(19) United States
(12) Patent Application Publication
(10) Pub. No.: US 2026/0246421 A1
(43) Pub. Date: Aug. 20, 2026

(54) SOLAR RACKING RAIL AND SYSTEMS THEREOF

(71) Applicant: Unirac, Inc., Albuquerque, NM (US)

(72) Inventor: Neha Avadhoot, Telangana (IN)

(21) Appl. No.: 19/058,448

(22) Filed: Feb. 20, 2025

(51) Int. Cl. H02S 30/10

(52) U.S. Cl. CPC H02S 30/10

(57) ABSTRACT

A mounting rail system includes a rail segment. The rail segment includes a first vertical wall extending in a first direction. The first vertical wall includes a first lower portion, a first flared portion extending in a second direction, and a first upper portion extending from the first flared portion. A second vertical wall extends in a third direction. The second vertical wall includes a second lower portion, a second flared portion extending in a fourth direction, and a second upper portion extending from the second flared portion. A horizontal base extends in a fifth direction. A first support wall extends from the horizontal base to the first vertical wall. A second support wall extends from the horizontal base to the second vertical wall, and a support bridge extends from the first support wall to the second support wall.

### BACKGROUND

As the solar energy industry continues to grow, the equipment to mount photovoltaic (PV) modules on different types of structures and/or locations continues to adapt and improve as well. Conventional PV module mounting rails must be strong enough to secure multiple solar panel modules and attachments and also support transient weight fluctuations (e.g., a person stepping on a rail and/or mounted solar panel module, snow loads, strong winds, etc.). However, increased strength in mounting rails often requires additional construction material which causes increased weight and increased cost to produce the mounting rail. Despite the numerous existing mounting rails for solar panel modules and components, there is room for improvement.

### BRIEF DESCRIPTION OF THE DRAWINGS

FIG. 1 illustrates a top-front perspective view of a mounting rail, according to an embodiment of this disclosure.

FIG. 1A illustrates a cross-sectional side view of the mounting rail of FIG. 1, according to an embodiment in this disclosure.

FIG. 1B illustrates a cross-sectional side view of the mounting rail of FIG. 1 and a cross-sectional side view of a complementary splice rail, according to an embodiment of this disclosure.

FIG. 1C illustrates a cross-sectional side view of a mounting rail system for the mounting rail of FIG. 1, according to an embodiment of this disclosure.

FIG. 1D illustrates a top perspective view of a solar panel mounting system including a rail segment and a rail mount, according to an embodiment of this disclosure.

FIG. 2 illustrates a top-front perspective view of a mounting rail, according to an embodiment of this disclosure.

FIG. 2A illustrates a cross-sectional side view of the mounting rail of FIG. 2, according to an embodiment in this disclosure.

FIG. 2B illustrates the cross-sectional side view of the mounting rail of FIG. 2 and a cross-sectional side view of a complementary splice rail, according to an embodiment of this disclosure.

FIG. 3 illustrates a top-front perspective view of a mounting rail, according to an embodiment of this disclosure.

FIG. 3A illustrates a cross-sectional side view of the mounting rail of FIG. 3, according to an embodiment in this disclosure.

FIG. 3B illustrates the cross-sectional side view of the mounting rail of FIG. 3 and a cross-sectional side view of a complementary splice rail, according to an embodiment of this disclosure.

FIG. 4 illustrates a cross-sectional side view of a mounting rail, according to an embodiment in this disclosure.

FIG. 5 illustrates a cross-sectional side view of a mounting rail, according to an embodiment in this disclosure.

FIG. 6 illustrates a cross-sectional side view of a mounting rail, according to an embodiment in this disclosure.

FIG. 7 illustrates a cross-sectional side view of a mounting rail, according to an embodiment in this disclosure.

FIG. 8 illustrates a cross-sectional side view of a mounting rail, according to an embodiment in this disclosure.

FIG. 9 illustrates a cross-sectional side view of a mounting rail, according to an embodiment in this disclosure.

FIG. 10 illustrates a cross-sectional side view of a mounting rail, according to an embodiment in this disclosure.

FIG. 11 illustrates a cross-sectional side view of a mounting rail according to an embodiment of this disclosure.

FIG. 12 illustrates a top-front perspective view of the mounting rail of FIG. 11, according to an embodiment of this disclosure.

### DETAILED DESCRIPTION

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

This disclosure is directed to a mounting rail used to mount solar panel modules and other photovoltaic (PV) components to a roof. More specifically, compared with traditional mounting rails, the embodiments of a mounting rail as described herein may have advantages including increased strength, durability, rigidity, and resistance to deformation.

In an embodiment, the mounting rail may include a first vertical wall, a second vertical wall, and a horizontal base. In an embodiment, the mounting rail may include one or more support walls that may extend from the vertical walls and/or the horizontal base at various angles relative to the horizontal base. In an embodiment, various portions of the vertical walls, the horizontal base, and/or the support walls may be reinforced (e.g., thicker, different material, added material, etc.).

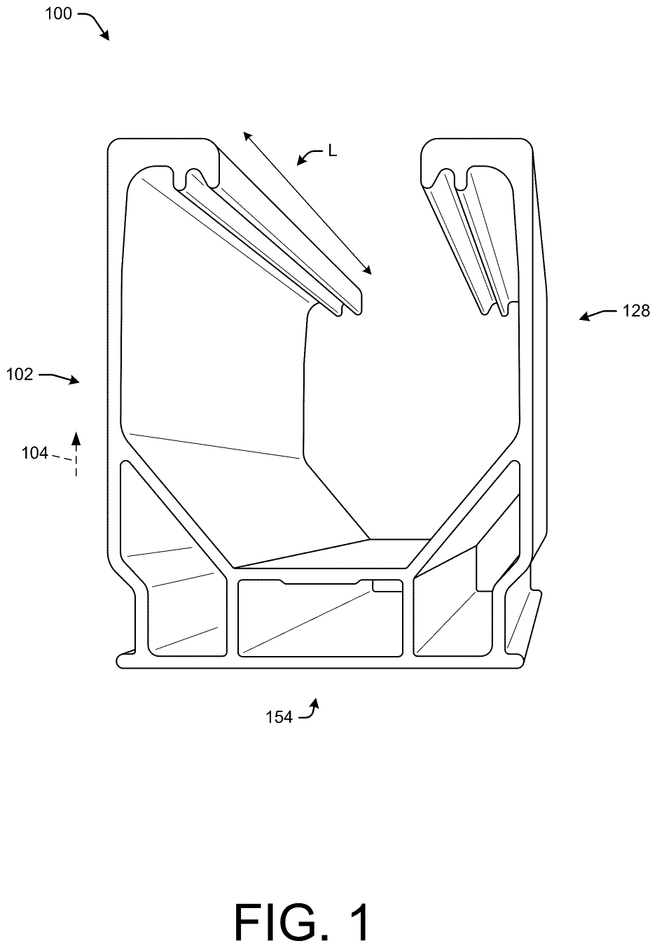

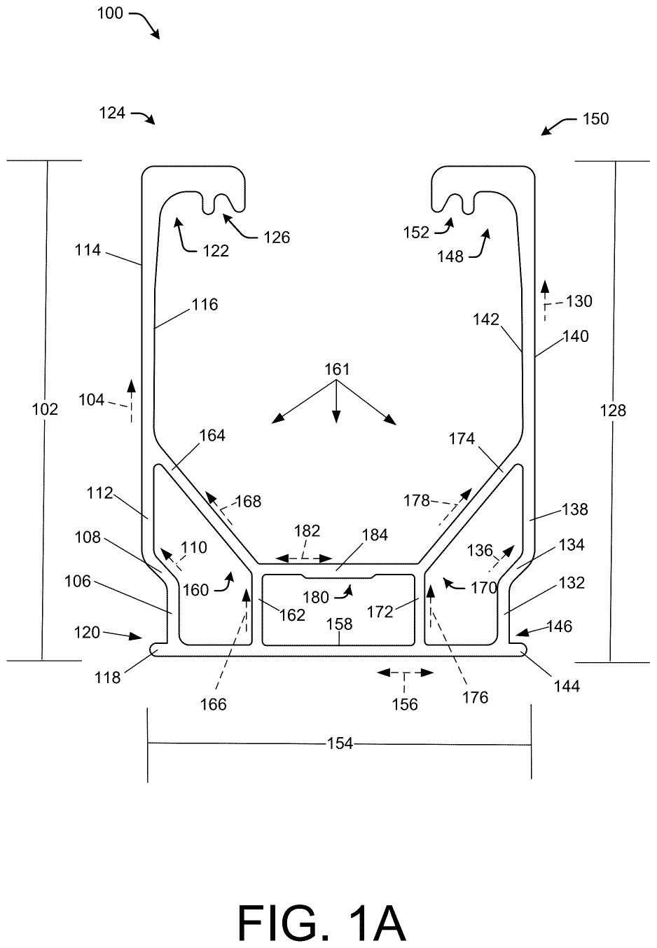

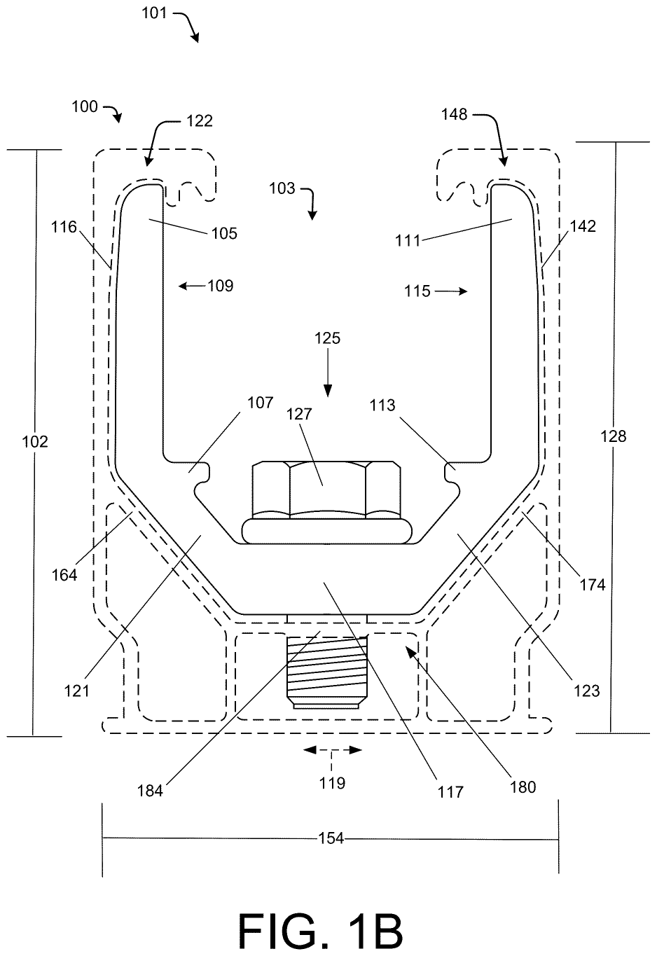

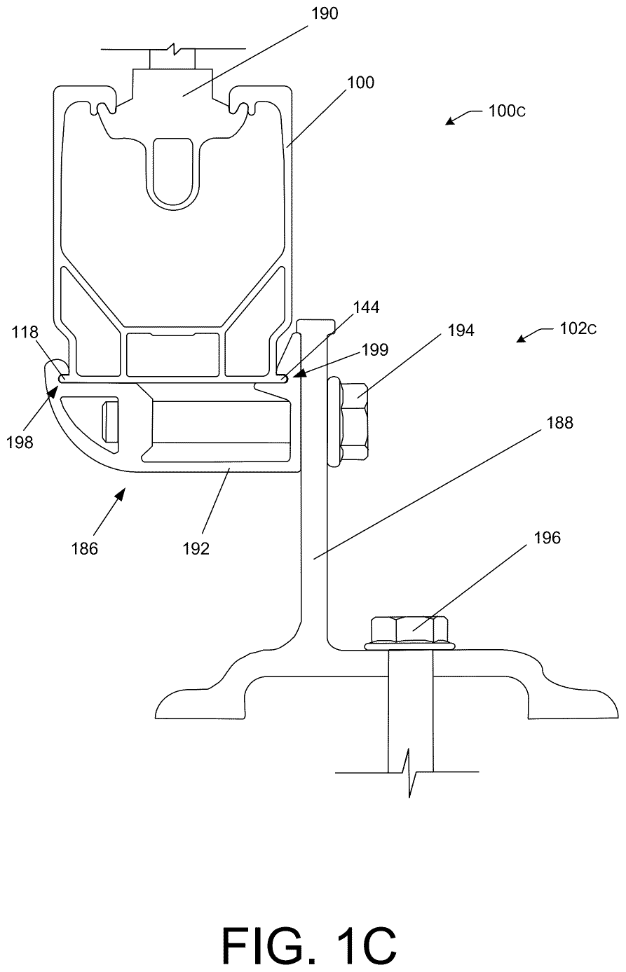

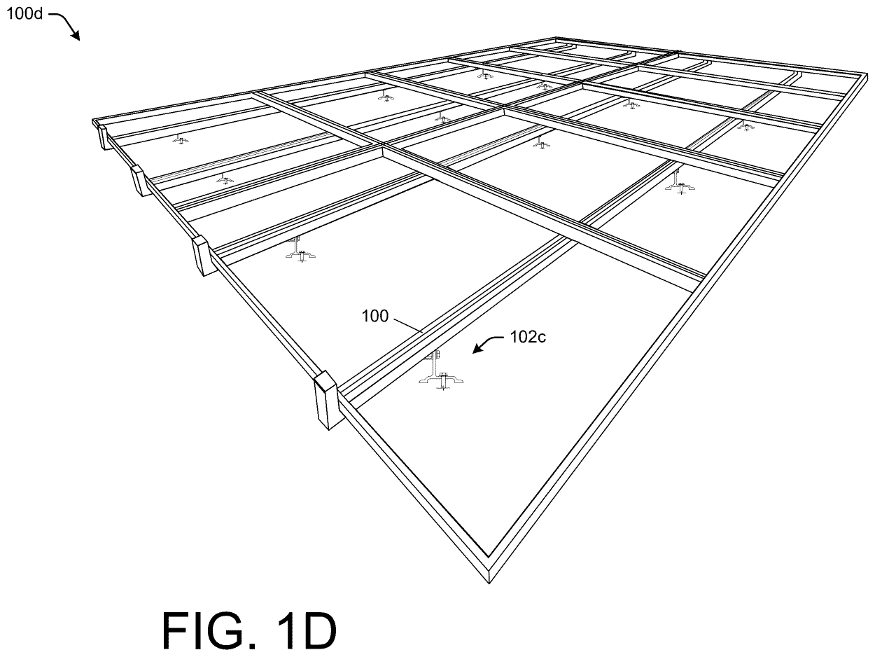

Turning to the drawings, FIG. 1 illustrates a top-front perspective view of a mounting rail (“rail 100”), according to an embodiment of this disclosure. In an embodiment, the rail 100 includes a first vertical wall 102 and a second vertical wall 128, each of which extends primarily in a first direction 104 with respect to horizontal base 154. Thus, an overall U-shaped channel profile may be defined by a cross-sectional view of the first vertical wall 102, the second vertical wall 128, and the horizontal base 154, when the horizontal base 154 is oriented to extend horizontally.

FIG. 1A illustrates a cross-sectional side view of the mounting rail of FIG. 1 (“rail 100”), according to an embodiment in this disclosure. In an embodiment, the first vertical wall 102 has a lower portion 106 extending in the first direction 104 connected to an angled portion 108 extending in a second direction 110 that is transverse to the first direction 104, which is further connected to an upper portion 112 extending in the first direction 104.

The first vertical wall 102 has an outside surface 114 opposite an inside surface 116. The first vertical wall 102 includes a first protrusion 118 protruding from the outside surface 114 at a bottom end 120 thereof. The first protrusion 118 is correspondingly shaped to be received by a rail mounting clamp (not shown).

The first vertical wall 102 may also include a first inner groove 122 that extends in a direction longitudinally along a length L of the rail 100 and is disposed at a top end 124 of the inside surface 116 of the first vertical wall 102. The first inner groove 122 may be configured to receive a top portion of a first vertical wall of a splice rail (not shown in FIG. 1A, see FIG. 1B). In an embodiment, the top end 124 of the first vertical wall 102 may be thicker than the bottom end 120 of the first vertical wall 102. It is also understood that the inside surface 116 of the first vertical wall 102 may be tapered inwardly such that the lower portion 106 of the first vertical wall 102 is more narrow than the top end 124 of the upper portion 112 of the first vertical wall 102. An advantage of the tapering of the inside surface 116 at the top end 124 of the first vertical wall 102, which creates an increasingly greater wall thickness extending upwardly, is that the tapering may provide additional strength and stability.

The first vertical wall 102 may further include a second inner groove 126 that extends longitudinally along the length of the rail 100 and is laterally adjacent and parallel to the first inner groove 122, and thus also is disposed at the top end 124 of the inside surface 116 of the first vertical wall 102. The second inner groove 126 may be configured to receive a first cooperating portion of a PV component mounting attachment (e.g., a rail nut) (not shown in FIG. 1A, see FIG. 1C). As shown, the first inner groove 122 may be located more proximate to the inside surface 116 as compared to the second inner groove 126.

As depicted, the rail 100 includes a second vertical wall 128 that stands opposite from, and extends in, a third direction 130 parallel to the first direction 104 of the first vertical wall 102. The second vertical wall 128 has a lower portion 132 extending in the third direction 130, an angled portion 134 extending in a fourth direction 136, and an upper portion 138 extending in the third direction 130. The second vertical wall 128 has an outside surface 140 opposite an inside surface 142. The second vertical wall 128 may include the second protrusion 144 protruding from the outside surface 140 of the second vertical wall 128 at a bottom end 146 thereof.

The second vertical wall 128 may include a third inner groove 148 that extends longitudinally along a length of the rail 100 and is disposed at a top end 150 of the inside surface 142 of the second vertical wall 128. The third inner groove 148 may be mirror-symmetric of the first inner groove 122 and may be configured to receive a top portion of a second vertical wall of the splice rail (not shown in FIG. 1A, see FIG. 1B). Like the first vertical wall 102, the second vertical wall 128 may include another mirror-symmetrical groove with respect to the second inner groove 126, (e.g., a fourth inner groove 152), that extends longitudinally along the length of the rail 100 and is laterally adjacent and parallel to the third inner groove 148, and thus also is disposed at the top end 150 of the inside surface 142 of the second vertical wall 128. The fourth inner groove 152 may be configured to receive a second cooperating portion of a PV component mounting attachment (e.g., a rail nut) (not shown in FIG. 1A). As shown, the third inner groove 148 may be located more proximate to the inside surface 142 as compared to the fourth inner groove 152.

In an embodiment, the top end 150 of the second vertical wall 128 may be thicker than the bottom end 146 of the second vertical wall 128. It is also understood that the inside surface 142 of the second vertical wall 128 may be tapered inwardly such that the lower portion 132 of the second vertical wall 128 is more narrow than the top end 150 of the upper portion 138 of the second vertical wall 128. An advantage of the tapering of the inside surface 142 at the top end 150 of the second vertical wall 128, which creates an increasingly greater wall thickness extending upwardly, is that the tapering may provide additional strength and stability.

The rail 100 further includes a horizontal base 154 extending in a fifth direction 156 transverse to the first direction 104 of the first vertical wall 102 and the third direction 130 of the second vertical wall 128. The horizontal base 154 also includes an inside surface 158. The horizontal base 154 thus connects to, and is integrally formed with, the bottom end 120 of the first vertical wall 102 and the bottom end 146 of the second vertical wall 128.

The rail 100 further includes a support structure 161. In an embodiment, the support structure 161 may include a first vertical support wall 160 that extends from the inside surface 158 of the horizontal base 154 to the inside surface 116 of the first vertical wall 102. The first vertical support wall 160 may include a base 162 and an arm 164. The base 162 may extend in a sixth direction 166 from the inside surface 158 of the horizontal base 154. The arm 164 may extend in a seventh direction 168 and extend from the base 162 to the inside surface 116 of the first vertical wall 102.

The support structure 161 further includes a second vertical support wall 170 that extends from the inside surface 158 of the horizontal base 154 to the inside surface 142 of the second vertical wall 128. The second vertical support wall 170 may include a base 172 and an arm 174. The base 172 may extend in an eighth direction 176 from the inside surface 158 of the horizontal base 154. The arm 174 may extend in a ninth direction 178 and extend from the base 172 to the inside surface 142 of the second vertical wall 128. An advantage of the rail 100 including the first vertical support wall 160 and the second vertical support wall 170 may be an increased resistance to torsion buckling of the rail 100 and/or greater resistance against localized buckling of the first vertical wall 102 and/or localized buckling of the second vertical wall 128.

The rail 100 may also include a bridge 180 that extends from the first vertical support wall 160 to the second vertical support wall 170 in a tenth direction 182. The bridge 180 may include a middle portion 184 that is reinforced (e.g., thicker than the adjacent portions of the bridge 180). An advantage of a reinforced middle portion 184 may be an increase in the ability of the middle portion 184 to maintain structural integrity if the middle portion 184 is penetrated (e.g., if a fastener extended through the middle portion 184).

The various directions referenced in FIG. 1A (e.g., first direction 104, second direction 110, third direction 130, etc.) may be depicted in the present disclosure as being distinct and separate for ease of reference. However, it is understood that in an embodiment, one or more referenced directions may be identified with separate reference numerals but may refer to the same direction. For example, in an embodiment, the first direction 104, the third direction 130, the sixth direction 166, and the eight direction 176 may extend in the same direction (e.g., vertically considering the intended installation orientation of the rail 100). Similarly, in an embodiment, the fifth direction 156 and the tenth direction 182 may extend in the same direction (e.g., horizontally considering the intended installation orientation of the rail 100), the second direction 110 and the seventh direction 168 may extend in the same direction (e.g., transverse to vertical and horizontal considering the intended installation of the rail 100), and the fourth direction 136 and the ninth direction 178 may extend in the same direction (e.g., transverse to vertical and horizontal considering the intended installation of the rail 100).

Additionally, various directions referenced in FIG. 1 may be depicted as being the same (e.g., the first direction 104, the third direction 130, the sixth direction 166, and the eighth direction 176). However, it is understood that the directions referenced in FIG. 1 may include one or more alternative orientations. For example, in an embodiment, the first direction 104 and the third direction 130 may extend in the same direction parallel to one another while the sixth direction 166 and the eighth direction 176 may be angled such that they are not parallel with the first direction 104 and the third direction 130.

FIG. 1B illustrates a cross-sectional side-view of a splice rail assembly 101. The splice rail assembly 101 may include the rail 100 and a splice rail 103 that is at least partially received by the rail 100. The splice rail 103 is configured to be partially received by a portion of a first segment of rail 100 and partially received by a portion of a second rail 100. The splice rail 103 may provide for a way to connect multiple rail segments in series by connecting, for example, a first segment of rail 100 to a second segment of rail 100 (not shown). Accordingly, the splice rail 103 provides longitudinal continuity between adjacent rail segments in a system, where the rail segments are placed end to end, creating a continuous mounting surface for PV component mounts. Each embodiment of the rails discussed hereinafter is also considered to be able to receive a splice rail, shaped accordingly, and thereby permit continuous extension of the rail, unless stated otherwise.

Accordingly, the splice rail 103 may include a top portion 105 and a protrusion 107 of a first vertical wall 109 and a top portion 111 and a protrusion 113 of a second vertical wall 115. The top portion 105 of the first vertical wall 109 may be a first cooperating portion (e.g., first portion) configured and shaped to be received by the first inner groove 122 disposed at the top end of the inside surface 116 of the first vertical wall 102 of the rail 100. The top portion 111 of the second vertical wall 115 may be a second cooperating portion (e.g., second portion) configured and shaped to be received by the third inner groove 148 disposed at the top end of the inside surface 142 of the second vertical wall 128 of the rail 100. The top portions 105 and 111 of the first and second vertical walls 109 and 115 of the splice rail 103 may be slidably received by the first and third inner grooves 122 and 148 of the rail 100 such that the splice rail 103 and/or the rail 100 may be secured at a desired location relative to each other.

The splice rail 103 further includes a horizontal base 117 extending generally in a direction 119 transverse to the first vertical wall 109 of the splice rail 103 and the second vertical wall 115 of the splice rail 103. The horizontal base 117 thus connects and is integrally formed with a bottom portion 121 of the first vertical wall 109 of the splice rail 103 and a bottom portion 123 of the second vertical wall 115 of the splice rail 103. Each protrusion 107 and 113 may extend away from its respective vertical wall in a direction parallel to the horizontal base 117. In an embodiment, the protrusions 107 and 113 may provide additional support to and strengthen the vertical walls 109 and 115.

A fastener 125 may be disposed in the horizontal base 117 such that a head 127 of the fastener 125 is positioned between the protrusion 107 of the first vertical wall 109 of the splice rail 103 and the protrusion 113 of the second vertical wall 115 of the splice rail 103 and disposed on top a top surface of the horizontal base 117. In an embodiment, the fastener 125 may be disposed through the horizontal base 117 and the horizontal base 154. The fastener 125 may be used to lock the splice rail 103 to a first segment of the rail 100 and/or a second segment of the rail 100. For example, when the fastener 125 is tightened, a portion (e.g., an end) of the fastener 125 may be driven through the middle portion 184 of the bridge 180 of rail 100. As the fastener 125 is tightened, the horizontal base 117 is pulled closer to the bridge 180. In an embodiment, when the fastener is fully tightened, the bottom portion 121 may planarly engage with the arm 164, the horizontal base 117 may planarly engage with the bridge 180, and the bottom portion 123 planarly contacts arm 174.

In an embodiment, tightening the fastener 125 into the rail 100 may compress the top portions 105 and 111 of the first and second vertical walls 109 and 115 of the splice rail 103 into the first and third inner grooves 122 and 148 of rail 100. In an embodiment, when the fastener 125 is tightened, a nut attached to the fastener 125 underneath the splice rail 103 may clamp the splice rail 103 together with the rail 100. The fastener 125 provides for electrical bonding of a first segment of the rail 100 connected to the splice rail 103 to an adjacent second segment of rail 100 connected to the splice rail 103. For example, the fastener 125 may include one or more protrusions (e.g., serrations, teeth, etc.) arranged on the underside of the head 127 of the fastener 125 that penetrate anodization on rails, thus bonding rails together.

FIG. 1C illustrates a cross-sectional side view of a mounting rail system 100c (“system 100c”) for mounting the rail 100 of FIG. 1, according to an embodiment of this disclosure.

In an embodiment, the system 100c may include the rail 100 and a rail mount 102c, and a PV component mounting attachment (e.g., rail nut, bonding washer, etc.) 190. In an embodiment, the rail mount 102c may include a clamp 186, a base 188. In an embodiment, the clamp 186 may include a body 192 and a fastener 194. The base 188 may also include a fastener 196. In an embodiment, the base 188 may be installed on a roof utilizing fastener 196.

When the clamp 186 receives a segment of rail 100, to secure the segment of rail 100 to the base 188, at least a first protrusion 118 of the segment of rail 100 is received by a first groove 198 of the clamp 186 and the body 192 is urged to flex and to displace the a groove 199 disposed in the clamp 186 opposite of the first groove 198 at a distance such that at least a second protrusion 144 of the segment of rail 100 is received by the second groove 199. For example, during coupling of the segment of rail 100, the body 192 may flex to enable the first protrusion 118 to engage with the first groove 198 and the second protrusion 144 to engage the second groove 199. Furthermore, the clamp 186 may utilize the fastener 194 for securing the segment of rail 100 in place to the clamp 186 and securing the clamp 186 to the base 188. That is, the fastener 194 may prevent the body 192 from being able to flex, thus holding the first and second protrusions 118 and 144, respectively, in first and second grooves 198 and 199. The fastener 194 may also be tightened to draw the clamp 186 closer to the base 188, thus securing the clamp 186 against the base 188.

FIG. 1D illustrates a top perspective view of a solar panel mounting system 100d including a segment of rail 100 and a rail mount 102c, according to an embodiment of this disclosure. While FIG. 1D illustrates the mounting system 100d including one segment of rail 100, the mounting system 100d may include a plurality of segments of rail 100. For example, a plurality of segments of rail 100 may be disposed underneath rows of solar panel modules for the length of the array of solar panel modules. While the mounting system 100d may be used for mounting solar panel modules on a rail segment structure, it is understood that there may be additional uses for one or more of the components of the mounting system 100d. For example, the mounting system 100d may be adapted for use to mount other objects and or technologies.

Returning to the mounting system 100d, the segment rail of 100 may be attached to the mount 102c that may be mounted to a roof or other surface (e.g., walls, the ground, poles, bridges, vehicles, etc.) Accordingly, the segment of rail 100 may be attached to the mount 102c in a variety of location. It is understood that although mounting system 100d is described herein as specifically being compatible with rail 100, it is understood that mounting system 100d may be compatible with any rail within this disclosure (e.g., rail 200, 300, 400, 500, 600, 700, 800, 900, 1000).

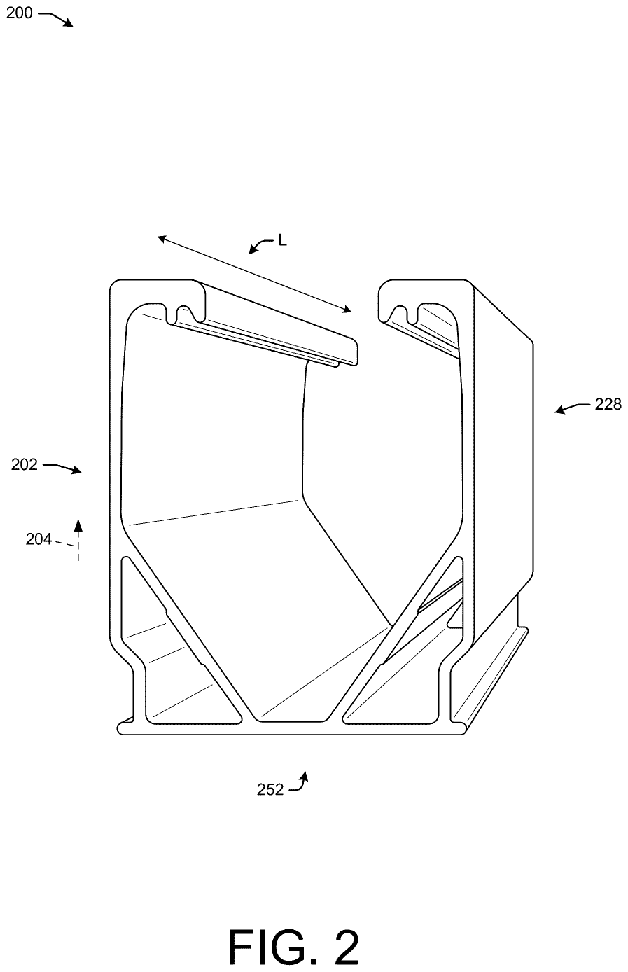

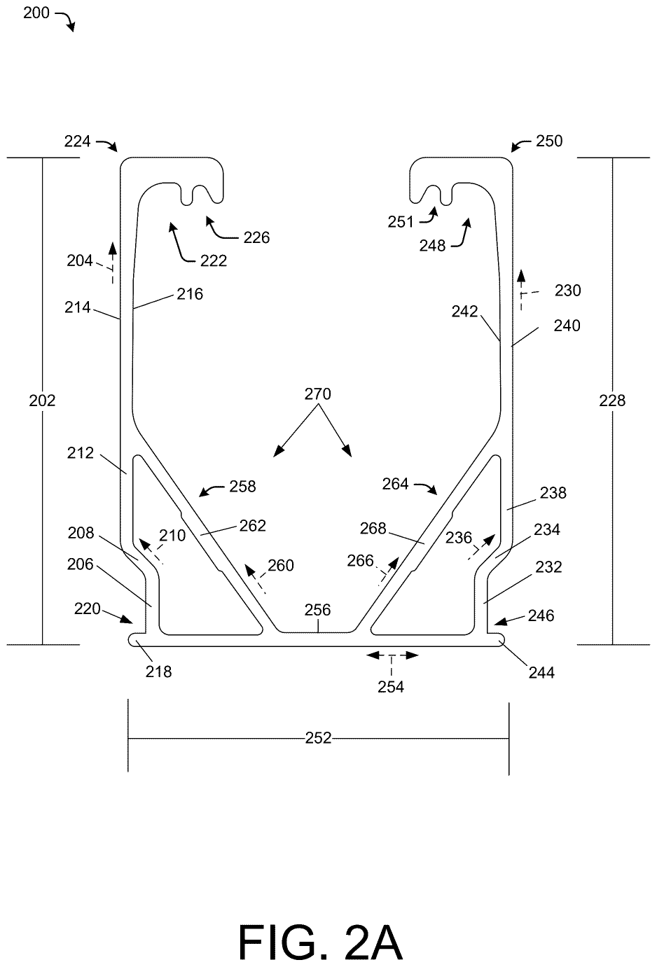

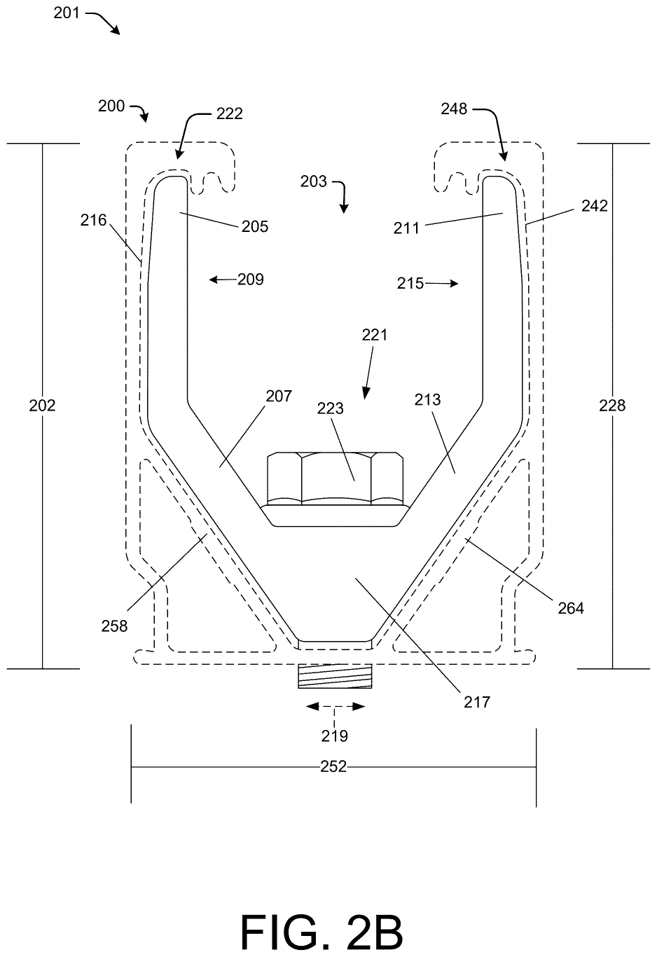

FIG. 2 illustrates a top-front perspective view of a mounting rail (“rail 200”), according to an embodiment of this disclosure. In an embodiment, the rail 200 includes a first vertical wall 202 and a second vertical wall 228, each of which extends primarily in a first direction 204 with respect to horizontal base 252. Thus, an overall U-shaped channel profile may be defined by a cross-sectional view of the first vertical wall 202, the second vertical wall 228, and the horizontal base 252, when the horizontal base 252 is oriented to extend horizontally.

FIG. 2A illustrates a cross-sectional side view of the mounting rail of FIG. 2 (“rail 200”), according to an embodiment in this disclosure. The first vertical wall 202 has a lower portion 206 extending in the first direction 204, an angled portion 208 extending in a second direction 210, and an upper portion 212 extending in the first direction 204. The first vertical wall 202 has an outside surface 214 opposite an inside surface 216. The first vertical wall 202 includes the first protrusion 218 protruding from the outside surface 214 at a bottom end 220 of the first vertical wall 202 thereof. The first protrusion 218 is correspondingly shaped to be received by a rail mounting clamp (not shown).

The first vertical wall 202 may also include a first inner groove 222 that extends in a direction longitudinally along a length L of the rail 200 and is disposed at a top end 224 of the inside surface 216 of the first vertical wall 202. The first inner groove 222 may be configured to receive a top portion of a first vertical wall of a splice rail (not shown in FIG. 2A, see FIG. 2B). In an embodiment, the top end 224 of the first vertical wall 202 may be thicker than the bottom end 220 of the first vertical wall 202. It is also understood that the inside surface 216 of the first vertical wall 202 may be tapered inwardly such that the lower portion 206 of the first vertical wall 202 is more narrow than the top end 224 of the upper portion 212 of the first vertical wall 202. An advantage of the tapering of the inside surface 216 at the top end 224 of the first vertical wall 202, which creates an increasingly greater wall thickness extending upwardly, may provide additional strength and stability.

The first vertical wall 202 may include a second inner groove 226 that extends longitudinally along the length of the rail 200 and is adjacent and parallel to the first inner groove 222, and thus also is disposed at the top end 224 of the inside surface 216 of the first vertical wall 202. The second inner groove 226 may be configured to receive a first cooperating portion of a PV component mounting attachment (e.g., a rail nut) (not shown in FIG. 2A). As shown, the first inner groove 222 may be located more proximate to the inside surface 216 as compared to the second inner groove 226.

As depicted, the rail 200 includes a second vertical wall 228 that stands opposite from, and extends in, a third direction 230 parallel to the first direction 204 of the first vertical wall 202. The second vertical wall 228 has a lower portion 232 extending in the third direction 230, an angled portion 234 extending in a fourth direction 236, and an upper portion 238 extending in the first direction 204. The second vertical wall 228 has an outside surface 240 opposite an inside surface 242. The second vertical wall 228 may include the second protrusion 244 protruding from the outside surface 240 of the second vertical wall 228 at a bottom end 246 thereof.

The second vertical wall 228 may include a third inner groove 248 that extends longitudinally along a length of the rail 200 and is disposed at a top end 250 of the inside surface 242 of the second vertical wall 228. The third inner groove 248 may be mirror-symmetric of the first inner groove 222 and may be configured to receive a top portion of a second vertical wall of the splice rail (not shown in FIG. 2A, see FIG. 2B). Like the first vertical wall 202, the second vertical wall 228 may include another mirror-symmetrical groove with respect to the second inner groove 226, (e.g., a fourth inner groove 251), that extends longitudinally along the length of the rail 200 and is adjacent and parallel to the third inner groove 248, and thus also is disposed at the top end 250 of the inside surface 242 of the second vertical wall 228. The fourth inner groove 251 may be configured to receive a second cooperating portion of a PV component mounting attachment (e.g., a rail nut) (not shown in FIG. 2A). As shown, the third inner groove 248 may be located more proximate to the inside surface 242 as compared to the fourth inner groove 251.

In an embodiment, the top end 250 of the second vertical wall 228 may be thicker than the bottom end 246 of the second vertical wall 228. It is also understood that the inside surface 242 of the second vertical wall 228 may be tapered inwardly such that the lower portion 232 of the second vertical wall 228 is more narrow than the top end 250 of the upper portion 238 of the second vertical wall 228. An advantage of the tapering of the inside surface 242 at the top end 250 of the second vertical wall 228, which creates an increasingly greater wall thickness extending upwardly, may provide additional strength and stability.

The rail 200 further includes a horizontal base 252 extending in a fifth direction 254 transverse to the first direction 204 of the first vertical wall 202 and the third direction 230 of the second vertical wall 228. The horizontal base 252 also includes an inside surface 256. The horizontal base 252 thus connects to, and is integrally formed with, the bottom end 220 of the first vertical wall 202 and the bottom end 246 of the second vertical wall 228.

The rail 200 further includes a support structure 270. In an embodiment, the support structure 270 may include a first support wall 258 that extends in a sixth direction 260 from the inside surface 256 of the horizontal base 252 to the inside surface 216 of the first vertical wall 202. The first support wall 258 may include a middle portion 262 that is reinforced (e.g., thicker than the adjacent portions of the middle portion 262).

The support structure 270 further includes a second support wall 264 that extends in a seventh direction 266 from the inside surface 256 of the horizontal base 252 to the inside surface 242 of the second vertical wall 228. The second support wall 264 may include a middle portion 268 that is reinforced (e.g., thicker than the adjacent portions of the middle portion 268).

The various directions referenced in FIG. 2A (e.g., the first direction 204, the second direction 210, the third direction 230, etc.) may be depicted in the present disclosure as being distinct and separate for ease of reference. However, it is understood that in an embodiment, one or more referenced directions may be identified with separate reference numerals but refer to the same direction. For example, in an embodiment, the first direction 204 and the third direction 230 may extend in the same direction (e.g., vertically considering the intended installation orientation of the rail 200). Similarly, the second direction 210 and the sixth direction 260 may extend in the same direction (e.g., transverse to vertical and horizontal considering the intended installation of the rail 200) parallel to each other, and the fourth direction 236 and the seventh direction 266 may extend in the same direction (e.g., transverse to vertical and horizontal considering the intended installation of the rail 200) parallel to each other.

Additionally, various directions referenced in FIG. 2A may be depicted as being the same (e.g., the second direction 210 and the sixth direction 260). However, it is understood that the directions referenced in FIG. 2A may include one or more alternative orientations. For example, in an embodiment, the second direction 210 and the sixth direction 260 may extend at different angles relative to the horizontal base 252.

FIG. 2B illustrates a cross-sectional side-view of a splice rail assembly 201. The splice rail assembly 201 may include the rail 200 and a splice rail 203 that is at least partially received by the rail 200. The splice rail 203 is configured to extend a running length of a line of consecutive rails by connecting, for example, a first segment of rail 200 to a second segment of rail 200 (not shown).

Accordingly, the splice rail 203 may include a top portion 205 and a bottom portion 207 of a first vertical wall 209 and a top portion 211 and a bottom portion 213 of a second vertical wall 215. The top portion 205 of the first vertical wall 209 may be a first cooperating portion (e.g., first portion) configured and shaped to be received by the first inner groove 222 disposed at the top end of the inside surface 216 of the first vertical wall 202 of the rail 200. The top portion 211 of the second vertical wall 215 may be a second cooperating portion (e.g., second portion) configured and shaped to be received by the third inner groove 248 disposed at the top end of the inside surface 242 of the second vertical wall 228 of the rail 200. The top portions 205 and 211 of the first and second vertical walls 209 and 215 of the splice rail 203 may be slidably received by the first and third inner grooves 222 and 248 of the rail 200 such that the splice rail 203 and/or the rail 200 may be secured at a desired location relative to each other. The bottom portions 207 and 213 may be configured to complement the inside surfaces of the first support wall 258 and the second support wall 264 of the rail 200.

The splice rail 203 further includes a horizontal base 217 extending generally in a direction 219 transverse to the first vertical wall 209 of the splice rail 203 and the second vertical wall 215 of the splice rail 203. The horizontal base 217 thus connects and is integrally formed with a bottom portion 207 of the first vertical wall 209 of the splice rail 203 and a bottom portion 213 of the second vertical wall 215 of the splice rail 203.

A fastener 221 may be disposed in the horizontal base 217 such that a head 223 of the fastener 221 is disposed between the bottom portion 207 of the first vertical wall 209 of the splice rail 203 and a bottom portion 213 of the second vertical wall 215 of the splice rail 203 and disposed on top a top surface of the horizontal base 217. In an embodiment, the fastener 221 may be disposed through the horizontal base 217 and the horizontal base 252. The fastener 221 may be used to lock the splice rail 203 to a first segment of the rail 200 and/or a second segment of the rail 200. For example, when the fastener 221 is tightened, a portion (e.g., an end) of the fastener 221 may be driven through the horizontal base 252 of the rail 200. As the fastener 221 is tightened, the horizontal base 217 is pulled closer to the horizontal base 252. In an embodiment, when the fastener is fully tightened, the bottom portion 207 may planarly engage with the first support wall 258, the horizontal base 117 may planarly engage with the horizontal base 252, and the bottom portion 213 planarly contacts the second support wall 264.

In an embodiment, tightening the fastener 221 into the rail 200 may compress the top portions 205 and 211 of the first and second vertical walls 209 and 215 of the splice rail 203 into the first and third inner grooves 222 and 248 of rail 200. In another example, when the fastener 221 is tightened, a nut attached to the fastener 221 underneath the splice rail 203 may clamp the splice rail 203 together with the rail 200. The fastener 221 provides for electrical bonding of a first segment of the rail 200 connected to the splice rail 203 to an adjacent second segment of rail 200 connected to the splice rail 203. For example, the fastener 221 may include one or more protrusions (e.g., serrations, teeth, etc.) arranged on the underside of the head 223 of the fastener 221 that penetrate anodization on rails, thus bonding rails together.

Notably, in an alternative way of describing the orientation of the elements shown in FIGS. 2, 2A, and 2B, it may be said that the horizontal base 252 extends in a first direction (or along a horizontal plane), and that the first vertical wall 202 and the second vertical wall 228 extend or protrude from the horizontal base 252 at respective inset positions therein. That is, the first protrusion 218 and the second protrusion 244 may be the opposing ends of the horizontal base 252. Moreover, the respective lower portions, 206, 232, of the first and second vertical walls 202, 228, may rise from the horizontal base 252 at a predetermined distance inset (i.e., the length of the protrusions 218, 244), respectively, from the opposing ends of the horizontal base 252. The same concept explained here may be applicable to any embodiment described herein below as is applicable (i.e., where protrusions are located at the base of the embodiment).

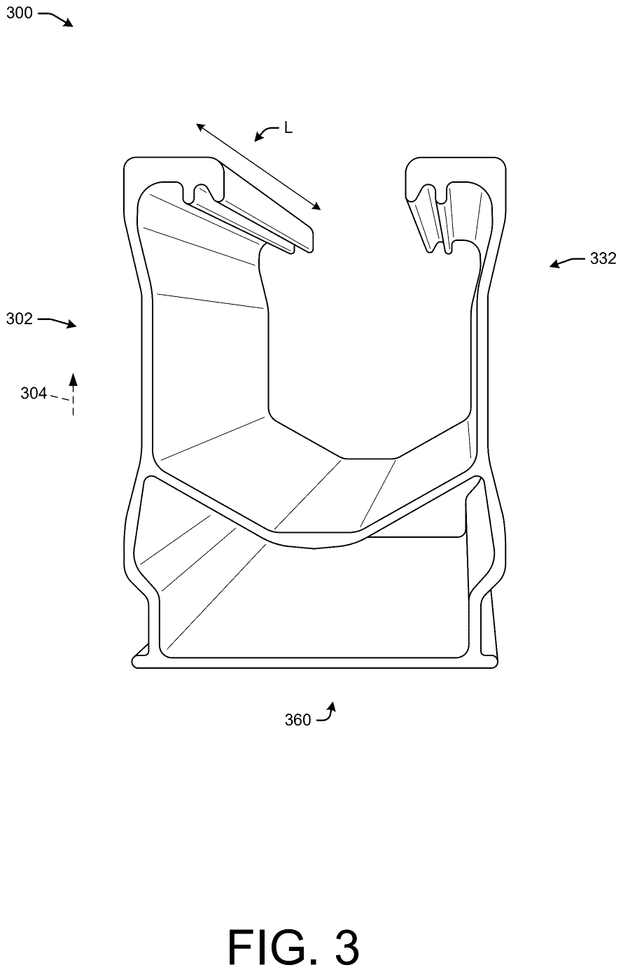

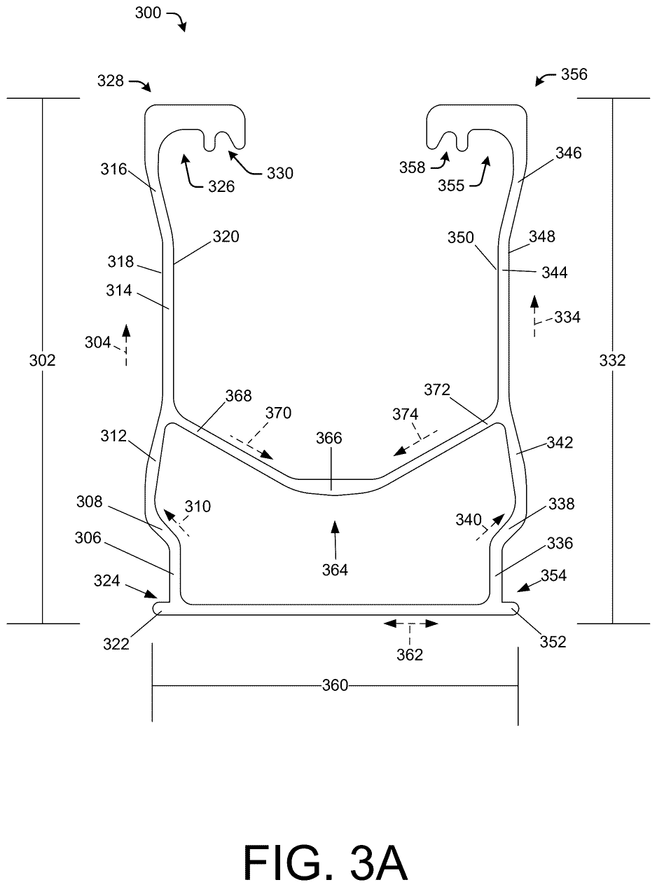

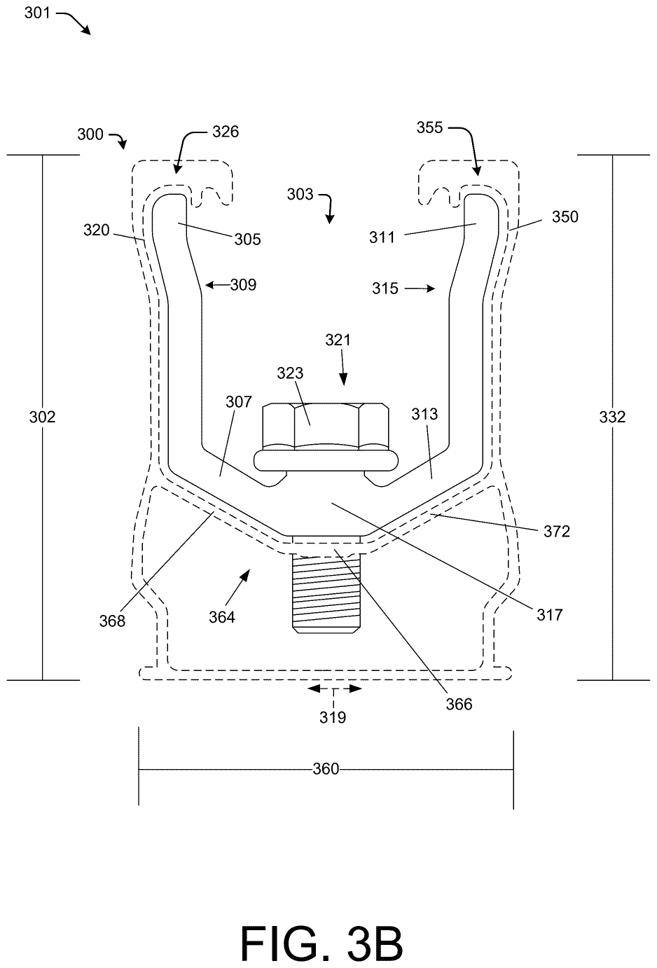

FIG. 3 illustrates a top-front perspective view of a mounting rail (“rail 300”), according to an embodiment of this disclosure. In an embodiment, the rail 300 includes a first vertical wall 302 and a second vertical wall 332, each of which extends primarily in a first direction 304 with respect to the horizontal base 360. Thus, an overall U-shaped channel profile may be defined by a cross-sectional view of the first vertical wall 302, the second vertical wall 332, and the horizontal base 360, when the horizontal base 360 is oriented to extend horizontally.

FIG. 3A illustrates a cross-sectional side view of a mounting rail (“rail 300”), according to an embodiment in this disclosure. The first vertical wall 302 has a lower portion 306 extending in the first direction 304, an angled portion 308 extending in a second direction 310, a lower curved portion 312, a middle portion 314 extending in the first direction 304, and an upper curved portion 316. The first vertical wall 302 has an outside surface 318 opposite an inside surface 320. The first vertical wall 302 includes the first protrusion 322 protruding from the outside surface 318 at a bottom end 324 of the first vertical wall 302 thereof. The first protrusion 322 is correspondingly shaped to be received by a rail mounting clamp (not shown).

The first vertical wall 302 may also include a first inner groove 326 that extends in a direction longitudinally along a length L of the rail 300 and is disposed at a top end 328 of the inside surface 320 of the first vertical wall 302. The first inner groove 326 may be configured to receive a top portion of a first vertical wall of a splice rail (not shown in FIG. 3A, see FIG. 3B). In an embodiment, the top end 328 of the first vertical wall 302 may be thicker than the bottom end 324 of the first vertical wall 302.

The first vertical wall 302 may include a second inner groove 330 that extends longitudinally along the length of the rail 300 and is adjacent and parallel to the first inner groove 326, and thus also is disposed at the top end 328 of the inside surface 320 of the first vertical wall 302. The second inner groove 330 may be configured to receive a first cooperating portion of a PV component mounting attachment (e.g., a rail nut) (not shown in FIG. 3A). As shown, the first inner groove 326 may be located more proximate to the inside surface 320 as compared to the second inner groove 330.

As depicted, the rail 300 includes a second vertical wall 332 that stands opposite from, and extends in, a third direction 334 parallel to the first direction 304 of the first vertical wall 302. The second vertical wall 332 has a lower portion 336 extending in the third direction 334, an angled portion 338 extending in a fourth direction 340, a lower curved portion 342, a middle portion 344 extending in the third direction 334, and an upper curved portion 346. The second vertical wall 332 has an outside surface 348 opposite an inside surface 350. The second vertical wall 332 may include the second protrusion 352 protruding from the outside surface 348 of the second vertical wall 332 at a bottom end 354 thereof.

The second vertical wall 332 may include a third inner groove 355 that extends longitudinally along a length of the rail 300 and is disposed at a top end 356 of the inside surface 350 of the second vertical wall 332. The third inner groove 355 may be mirror-symmetric of the first inner groove 326 and may be configured to receive a top portion of a second vertical wall of the splice rail (not shown in FIG. 3A, see FIG. 3B). Like the first vertical wall 302, the second vertical wall 332 may include another mirror-symmetrical groove with respect to the second inner groove 330, (e.g., a fourth inner groove 358) , that extends longitudinally along the length of the rail 300 and is adjacent and parallel to the third inner groove 355, and thus also is disposed at the top end 356 of the inside surface 350 of the second vertical wall 332. The fourth inner groove 358 may be configured to receive a second cooperating portion of a PV component mounting attachment (e.g., a rail nut) (not shown in FIG. 3A). As shown, the third inner groove 355 may be located more proximate to the inside surface 350 as compared to the fourth inner groove 358.

The rail 300 further includes a horizontal base 360 extending in a fifth direction 362 transverse to the first direction 304 of the first vertical wall 302 and the third direction 334 of the second vertical wall 332. The horizontal base 360 connects to, and is integrally formed with, the bottom end 324 of the first vertical wall 302 and the bottom end 354 of the second vertical wall 332.

The rail 300 includes a support structure 364 (e.g., bridge) that extends from the inside surface 320 of the first horizontal wall 302 to the inside surface 350 of the second horizontal wall 332. The bridge 364 may include a middle section 366, a first section 368 that extends from the inside surface 320 of the first horizontal wall 302 in a sixth direction 370 to the middle section 366, and a second section 372 that extends from the inside surface 350 of the second horizontal wall 332 in a seventh direction 374 to the middle section 366. The middle section 366 may be reinforced relative to the rest of the bridge 364 (e.g., the middle section 366 may be thicker than the first section 368 and/or or the second section 372).

The various directions referenced in FIG. 3A (e.g., first direction 304, second direction 310, third direction 334, etc.) may be depicted in the present disclosure as being distinct and separate for ease of reference. However, it is understood that in an embodiment, one or more referenced directions may be identified with separate reference numerals but refer to the same direction. For example, in an embodiment, the first direction 304 and the third direction 334 may extend in the same direction. Similarly, in an embodiment, the second direction 310 and the sixth direction 370 may extend in the same direction and at the same angle relative to the horizontal base 360. However, in an embodiment, the second direction 310 and the sixth direction 370 may extend in different directions at different angles relative to the horizontal base 360.

FIG. 3B illustrates a cross-sectional side-view of a splice rail assembly 301. The splice rail assembly 301 may include the rail 300 and a splice rail 303 that is at least partially received by the rail 300. The splice rail 303 is configured to extend a running length of a line of consecutive rails by connecting, for example, a first segment of rail 300 to a second segment of rail 300 (not shown).

Accordingly, the splice rail 303 may include a top portion 305 and a bottom portion 307 of a first vertical wall 309 and a top portion 311 and a bottom portion 313 of a second vertical wall 315. The top portion 305 of the first vertical wall 309 may be a first cooperating portion (e.g., first portion) configured and shaped to be received by the first inner groove 326 disposed at the top end of the inside surface 320 of the first vertical wall 302 of the rail 300. The top portion 311 of the second vertical wall 315 may be a second cooperating portion (e.g., second portion) configured and shaped to be received by the third inner groove 355 disposed at the top end of the inside surface 350 of the second vertical wall 332 of the rail 300. The top portions 305 and 311 of the first and second vertical walls 309 and 315 of the splice rail 303 may be slidably received by the first and third inner grooves 326 and 355 of the rail 300 such that the splice rail 303 and/or the rail 300 may be secured at a desired location relative to each other. The bottom portions 307 and 313 may be configured to complement the first section 368 of the bridge 364 and the second section 372 of the bridge 364.

The splice rail 303 further includes a horizontal base 317 extending generally in a direction 319 transverse to the first vertical wall 309 of the splice rail 303 and the second vertical wall 315 of the splice rail 303. The horizontal base 317 thus connects and is integrally formed with a bottom portion 307 of the first vertical wall 309 of the splice rail 303 and a bottom portion 313 the second vertical wall 315 of the splice rail 303.

A fastener 321 may be disposed in the horizontal base 317 such that a head 323 of the fastener 321 is disposed between the bottom portion 307 of the first vertical wall 309 of the splice rail 303 and a bottom portion 313 the second vertical wall 315 of the splice rail 303 and disposed on top a top surface of the horizontal base 317. In an embodiment, the fastener 321 may be disposed through the bridge 364 and the horizontal base 360. The fastener 321 may be used to lock the splice rail 303 to a first segment of the rail 300 and/or a second segment of the rail 300. For example, when the fastener 321 is tightened, a portion (e.g., an end) of the fastener 321 may be driven through the bridge 364 of the rail 300. As the fastener 321 is tightened, the horizontal base 317 is pulled closer to the middle section 366. In an embodiment, when the fastener is fully tightened, the bottom portion 307 may planarly engage with the first section 368, the horizontal base 317 may planarly engage with the middle section 366, and the bottom portion 313 planarly contacts second section 372.

In an embodiment, tightening the fastener 321 into the rail 300 may compress the top portions 305 and 311 of the first and second vertical walls 309 and 315 of the splice rail 303 into the first and third inner grooves 326 and 355 of rail 300. In another example, when the fastener 321 is tightened, a nut attached to the fastener 321 underneath the splice rail 303 may clamp the splice rail 303 together with the rail 300. The fastener 321 provides for electrical bonding of a first segment of the rail 300 connected to the splice rail 303 to an adjacent second segment of rail 300 connected to the splice rail 303. For example, the fastener 321 may include one or more protrusions (e.g., serrations, teeth, etc.) arranged on the underside of the head 323 of the fastener 321 that penetrate anodization on rails, thus bonding rails together.

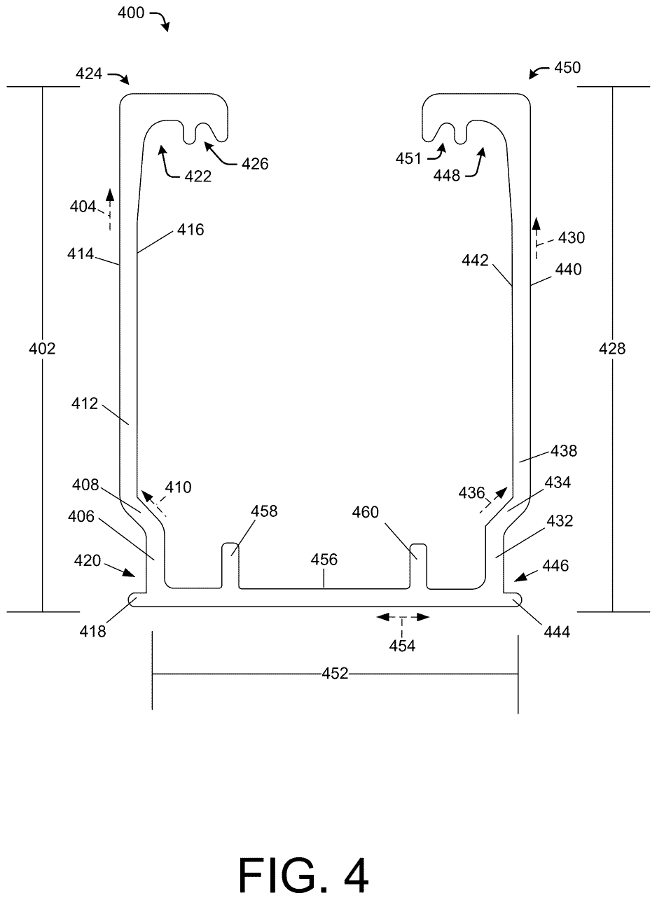

FIG. 4 illustrates a cross-sectional side view of a mounting rail (“rail 400”), according to an embodiment in this disclosure. The rail 400 includes a first vertical wall 402 in a first direction 404. The first vertical wall 402 has a lower portion 406 extending in the first direction 404, an angled portion 408 extending in a second direction 410, and an upper portion 412 extending in the first direction 404.

The first vertical wall 402 has an outside surface 414 opposite an inside surface 416. The first vertical wall 402 includes the first protrusion 418 protruding from the outside surface 414 at a bottom end 420 of the first vertical wall 402 thereof. The first protrusion 418 is correspondingly shaped to be received by a rail mounting clamp (not shown).

The first vertical wall 402 may also include a first inner groove 422 that extends longitudinally along a length of the rail 400 and is disposed at a top end 424 of the inside surface 416 of the first vertical wall 402. The first inner groove 422 may be configured to receive a top portion of a first vertical wall of a splice rail (not shown in FIG. 4). In an embodiment, the top end 424 of the first vertical wall 402 may be thicker than the bottom end 420 of the first vertical wall 402. It is also understood that the inside surface 416 of the first vertical wall 402 may be tapered inwardly such that the lower portion 406 of the first vertical wall 402 is more narrow than the top end 424 of the upper portion 412 of the first vertical wall 402. An advantage of the tapering of the inside surface 416 at the top end 424 of the first vertical wall 402, which creates an increasingly greater wall thickness extending upwardly, may provide additional strength and stability.

The first vertical wall 402 may include a second inner groove 426 that extends longitudinally along the length of the rail 400 and is adjacent and parallel to the first inner groove 422, and thus also is disposed at the top end 424 of the inside surface 416 of the first vertical wall 402. The second inner groove 426 may be configured to receive a first cooperating portion of a PV component mounting attachment (e.g., a rail nut) (not shown in FIG. 4). As shown, the first inner groove 422 may be located more proximate to the inside surface 416 as compared to the second inner groove 426.

As depicted, the rail 400 includes a second vertical wall 428 that stands opposite from, and extends in, a third direction 430 parallel to the first direction 404 of the first vertical wall 402. The second vertical wall 428 has a lower portion 432 extending in the third direction 430, an angled portion 434 extending in a fourth direction 436, and an upper portion 438 extending in the first direction 404. The second vertical wall 428 has an outside surface 440 opposite an inside surface 442. The second vertical wall 428 may include the second protrusion 444 protruding from the outside surface 440 of the second vertical wall 428 at a bottom end 446 thereof.

The second vertical wall 428 may include a third inner groove 448 that extends longitudinally along a length of the rail 400 and is disposed at a top end 450 of the inside surface 442 of the second vertical wall 428. The third inner groove 448 may be mirror-symmetric of the first inner groove 422 and may be configured to receive a top portion of a second vertical wall of the splice rail (not shown in FIG. 4). Like the first vertical wall 402, the second vertical wall 428 may include another mirror-symmetrical groove with respect to the second inner groove 426, (e.g., a fourth inner groove 451), that extends longitudinally along the length of the rail 400 and is adjacent and parallel to the third inner groove 448, and thus also is disposed at the top end 450 of the inside surface 442 of the second vertical wall 428. The fourth inner groove 451 may be configured to receive a second cooperating portion of a PV component mounting attachment (e.g., a rail nut) (not shown in FIG. 4). As shown, the third inner groove 448 may be located more proximate to the inside surface 442 as compared to the fourth inner groove 451.

In an embodiment, the top end 450 of the second vertical wall 428 may be thicker than the bottom end 446 of the second vertical wall 428. It is also understood that the inside surface 442 of the second vertical wall 428 may be tapered inwardly such that the lower portion 432 of the second vertical wall 428 is more narrow than the top end 450 of the upper portion 438 of the second vertical wall 428. An advantage of the tapering of the inside surface 442 at the top end 450 of the second vertical wall 428, which creates an increasingly greater wall thickness extending upwardly, may provide additional strength and stability.

The rail 400 further includes a horizontal base 452 extending in a fifth direction 454 transverse to the first direction 404 of the first vertical wall 402 and the third direction 430 of the second vertical wall 428. The horizontal base 452 also includes an inside surface 456. The horizontal base 452 thus connects to, and is integrally formed with, the bottom end 420 of the first vertical wall 402 and the bottom end 446 of the second vertical wall 428.

The rail 400 includes a first support protrusion 458 that extends from the inside surface 456 of the horizontal base 452 in a direction away from the horizontal base 452. The rail 400 may include a second support protrusion 460 that extends from the inside surface 456 of the horizontal base 452 in a direction away from the horizontal base 452.

The various directions referenced in FIG. 4 (e.g., first direction 404, second direction 410, third direction 430, etc.) may be depicted in the present disclosure as being distinct and separate for ease of reference. However, it is understood that in an embodiment, one or more referenced directions may be identified with separate reference numerals but refer to the same direction. For example, in an embodiment, the first direction 404 and the third direction 430 may extend in the same direction.

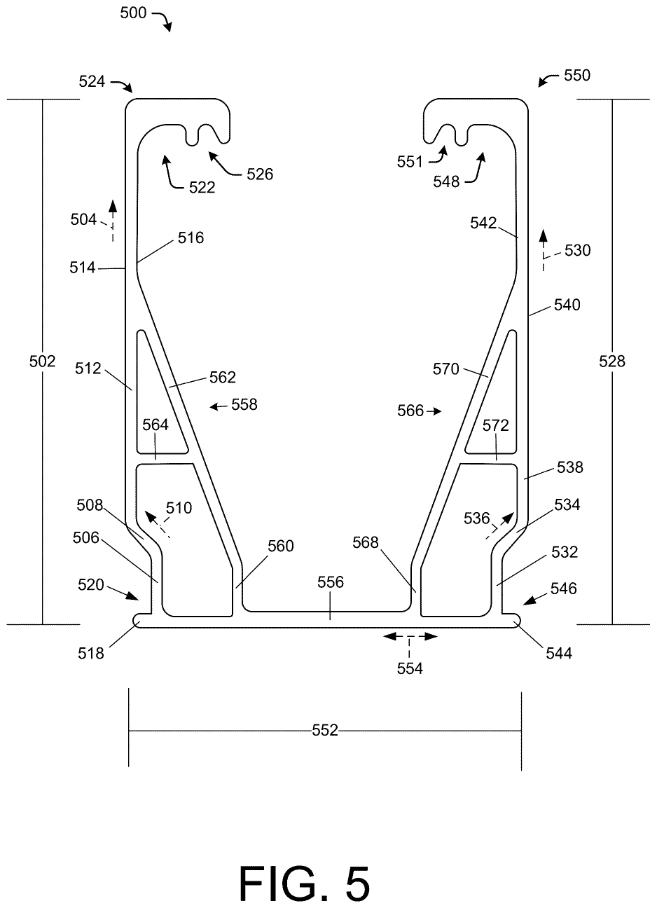

FIG. 5 illustrates a cross-sectional side view of a mounting rail (“rail 500”), according to an embodiment in this disclosure. The rail 500 includes a first vertical wall 502 in a first direction 504. The first vertical wall 502 has a lower portion 506 extending in the first direction 504, an angled portion 508 extending in a second direction 510, and an upper portion 512 extending in the first direction 504.

The first vertical wall 502 has an outside surface 514 opposite an inside surface 516. The first vertical wall 502 includes the first protrusion 518 protruding from the outside surface 514 at a bottom end 520 of the first vertical wall 502 thereof. The first protrusion 518 is correspondingly shaped to be received by a rail mounting clamp (not shown).

The first vertical wall 502 may also include a first inner groove 522 that extends longitudinally along a length of the rail 500 and is disposed at a top end 524 of the inside surface 516 of the first vertical wall 502. The first inner groove 522 may be configured to receive a top portion of a first vertical wall of a splice rail (not shown in FIG. 5). In an embodiment, the top end 524 of the first vertical wall 502 may be thicker than the bottom end 520 of the first vertical wall 502.

The first vertical wall 502 may include a second inner groove 526 that extends longitudinally along the length of the rail 500 and is adjacent and parallel to the first inner groove 522, and thus also is disposed at the top end 524 of the inside surface 516 of the first vertical wall 502. The second inner groove 526 may be configured to receive a first cooperating portion of a PV component mounting attachment (e.g., a rail nut) (not shown in FIG. 5). As shown, the first inner groove 522 may be located more proximate to the inside surface 516 as compared to the second inner groove 526.

As depicted, the rail 500 includes a second vertical wall 528 that stands opposite from, and extends in, a third direction 530 parallel to the first direction 504 of the first vertical wall 502. The second vertical wall 528 has a lower portion 532 extending in the third direction 530, an angled portion 534 extending in a fourth direction 536, and an upper portion 538 extending in the first direction 504. The second vertical wall 528 has an outside surface 540 opposite an inside surface 542. The second vertical wall 528 may include the second protrusion 544 protruding from the outside surface 540 of the second vertical wall 528 at a bottom end 546 thereof.

The second vertical wall 528 may include a third inner groove 548 that extends longitudinally along a length of the rail 500 and is disposed at a top end 550 of the inside surface 542 of the second vertical wall 528. The third inner groove 548 may be mirror-symmetric of the first inner groove 522 and may be configured to receive a top portion of a second vertical wall of the splice rail (not shown in FIG. 5). Like the first vertical wall 502, the second vertical wall 528 may include another mirror-symmetrical groove with respect to the second inner groove 526, (e.g., a fourth inner groove 551), that extends longitudinally along the length of the rail 500 and is adjacent and parallel to the third inner groove 548, and thus also is disposed at the top end 550 of the inside surface 542 of the second vertical wall 528. The fourth inner groove 551 may be configured to receive a second cooperating portion of a PV component mounting attachment (e.g., a rail nut) (not shown in FIG. 5). As shown, the third inner groove 548 may be located more proximate to the inside surface 542 as compared to the fourth inner groove 551.

The rail 500 further includes a horizontal base 552 extending in a fifth direction 554 transverse to the first direction 504 of the first vertical wall 502 and the third direction 530 of the second vertical wall 528. The horizontal base 552 thus connects to, and is integrally formed with, the bottom end 520 of the first vertical wall 502 and the bottom end 546 of the second vertical wall 528.

The rail 500 includes a first support wall 558 that extends from the horizontal base 552 to the inside surface 516 of the first vertical wall 502. The first support wall 558 includes a first base 560, a first arm 562, and a first bridge 564. The first base 560 may extend away from the horizontal base 552 in a direction parallel to the first direction 504. The first arm 562 may extend from the first base 560 in an angular direction toward the inside surface 516 of the first vertical wall 502. The first bridge 564 may extend from the first arm 562 to the inside surface 516 of the first vertical wall 502 in a direction transverse to the first direction 504.

The rail 500 includes a second support wall 566 that extends from the horizontal base 552 to the inside surface 542 of the second vertical wall 528. The second support wall 566 includes a second base 568, a second arm 570, and a second bridge 572. The second base 568 may extend away from the horizontal base 552 in a direction parallel to the third direction 530. The second arm 570 may extend from the second base 568 in an angular direction toward the inside surface 542 of the second vertical wall 528. The second bridge 572 may extend from the second arm 570 to the inside surface 542 of the second vertical wall 528 in a direction transverse to the third direction 530. The horizontal base 552 also includes a middle portion 556 that extends horizontally between the first base 560 and the second base 568. In an embodiment, the middle portion 556 may be reinforced (e.g., the middle portion 556 of the horizontal base 552 may be thicker than the adjacent portions of the horizontal base 552).

The various directions referenced in FIG. 5 (e.g., first direction 504, second direction 510, third direction 530, etc.) may be depicted in the present disclosure as being distinct and separate for ease of reference. However, it is understood that in an embodiment, one or more referenced directions may be identified with separate reference numerals but refer to the same direction. For example, in an embodiment, the first direction 504 and the third direction 530 may extend in the same direction.

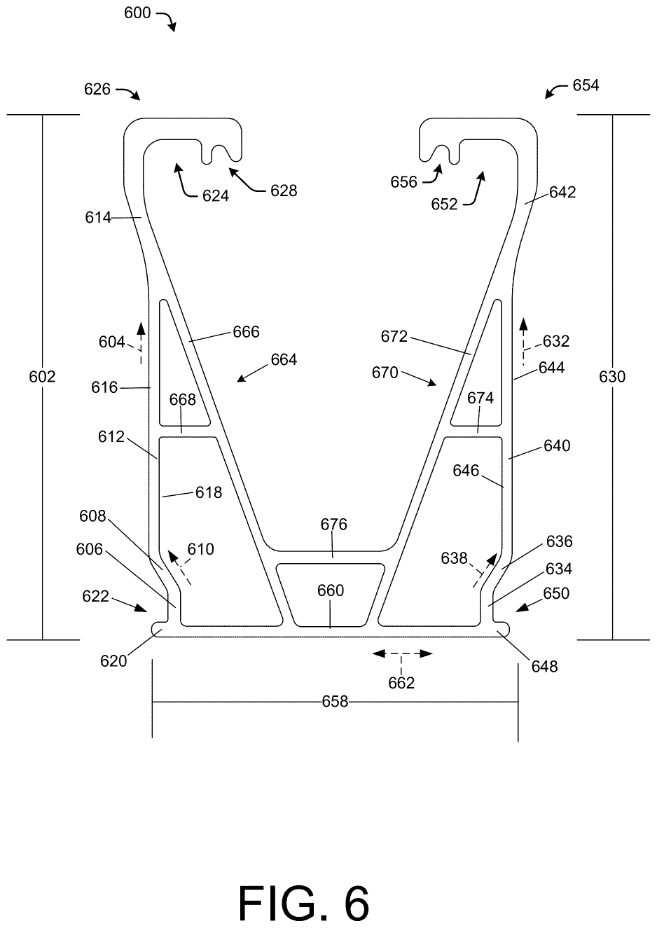

FIG. 6 illustrates a cross-sectional side view of a mounting rail (“rail 600”), according to an embodiment in this disclosure. The rail 600 includes a first vertical wall 602 in a first direction 604. The first vertical wall 602 has a lower portion 606 extending in the first direction 604, a first angled portion 608 extending in a second direction 610, an upper portion 612 extending in the first direction 604, and a second angled portion 614 extending from the upper portion 612 in a direction away from an outside surface 616 of the first vertical wall 602.

The first vertical wall 602 has an inside surface 618 opposite the outside surface 616. The first vertical wall 602 includes the first protrusion 620 protruding from the outside surface 616 at a bottom end 622 of the first vertical wall 602 thereof. The first protrusion 620 is correspondingly shaped to be received by a rail mounting clamp (not shown).

The first vertical wall 602 may also include a first inner groove 624 that extends longitudinally along a length of the rail 600 and is disposed at a top end 626 of the inside surface 616 of the first vertical wall 602. The first inner groove 624 may be configured to receive a top portion of a first vertical wall of a splice rail (not shown in FIG. 6). In an embodiment, the top end 626 of the first vertical wall 602 may be thicker than the bottom end 622 of the first vertical wall 602. In an embodiment, the second angled portion 614 may be thicker than the upper portion 612, the first angled portion 608, and/or the lower portion 606.

The first vertical wall 602 may include a second inner groove 628 that extends longitudinally along the length of the rail 600 and is adjacent and parallel to the first inner groove 624, and thus also is disposed at the top end 626 of the inside surface 618 of the first vertical wall 602. The second inner groove 628 may be configured to receive a first cooperating portion of a PV component mounting attachment (e.g., a rail nut) (not shown in FIG. 6). As shown, the first inner groove 624 may be located more proximate to the inside surface 618 as compared to the second inner groove 628.

As depicted, the rail 600 includes a second vertical wall 630 that stands opposite from, and extends in, a third direction 632 parallel to the first direction 604 of the first vertical wall 602. The second vertical wall 630 has a lower portion 634 extending in the third direction 632, a first angled portion 636 extending in a fourth direction 638, an upper portion 640 extending in the third direction 632, and a second angled portion 642 extending from the upper portion 640 in a direction away from an outside surface 644 of the second vertical wall 630. The second vertical wall 630 has an inside surface 646 opposite the outside surface 644. The second vertical wall 630 may include the second protrusion 648 protruding from the outside surface 644 of the second vertical wall 630 at a bottom end 650 thereof.

The second vertical wall 630 may include a third inner groove 652 that extends longitudinally along a length of the rail 600 and is disposed at a top end 654 of the inside surface 646 of the second vertical wall 630. The third inner groove 652 may be mirror-symmetric of the first inner groove 624 and may be configured to receive a top portion of a second vertical wall of the splice rail (not shown in FIG. 6). Like the first vertical wall 602, the second vertical wall 630 may include another mirror-symmetrical groove with respect to the second inner groove 628, (e.g., a fourth inner groove 656), that extends longitudinally along the length of the rail 600 and is adjacent and parallel to the third inner groove 652, and thus also is disposed at the top end 654 of the inside surface 646 of the second vertical wall 630. The fourth inner groove 656 may be configured to receive a second cooperating portion of a PV component mounting attachment (e.g., a rail nut) (not shown in FIG. 6). As shown, the third inner groove 652 may be located more proximate to the inside surface 646 as compared to the fourth inner groove 656.

The rail 600 further includes a horizontal base 658 extending in a fifth direction 662 transverse to the first direction 604 of the first vertical wall 602 and the third direction 632 of the second vertical wall 630. The horizontal base 658 includes an inside surface 660. The horizontal base 658 thus connects to, and is integrally formed with, the bottom end 622 of the first vertical wall 602 and the bottom end 650 of the second vertical wall 630.

The rail 600 includes a first support wall 664 that extends from the inside surface 660 of the horizontal base 658 to the inside surface 618 of the first vertical wall 602. The first support wall 664 includes an arm 666 and a bridge 668. The arm 666 may extend from the inside surface 660 of the horizontal base 658 in an angular direction to the inside surface 618 of the first vertical wall 602 adjacent to the second angled portion 614. The first bridge 668 may extend from the arm 666 to the inside surface 618 of the first vertical wall 602 in a direction transverse to the first direction 604.

The rail 600 includes a second support wall 670 that extends from the inside surface 660 of the horizontal base 658 to the inside surface 646 of the second vertical wall 630. The second support wall 670 includes an arm 672 and a bridge 674. The arm 672 may extend from the inside surface 660 of the horizontal base 658 in an angular direction to the inside surface 646 of the second vertical wall 630 adjacent to the second angled portion 642. The bridge 674 may extend from the arm 672 to the inside surface 646 of the second vertical wall 630 in a direction transverse to the third direction 632. The rail 600 includes a support bridge 676 that extends from the first support wall 664 to the second support wall 670 in a direction parallel to the fifth direction 662.

The various directions referenced in FIG. 6 (e.g., first direction 604, second direction 610, third direction 632, etc.) may be depicted in the present disclosure as being distinct and separate for ease of reference. However, it is understood that in an embodiment, one or more referenced directions may be identified with separate reference numerals but refer to the same direction. For example, in an embodiment, the first direction 604 and the third direction 632 may extend in the same direction.

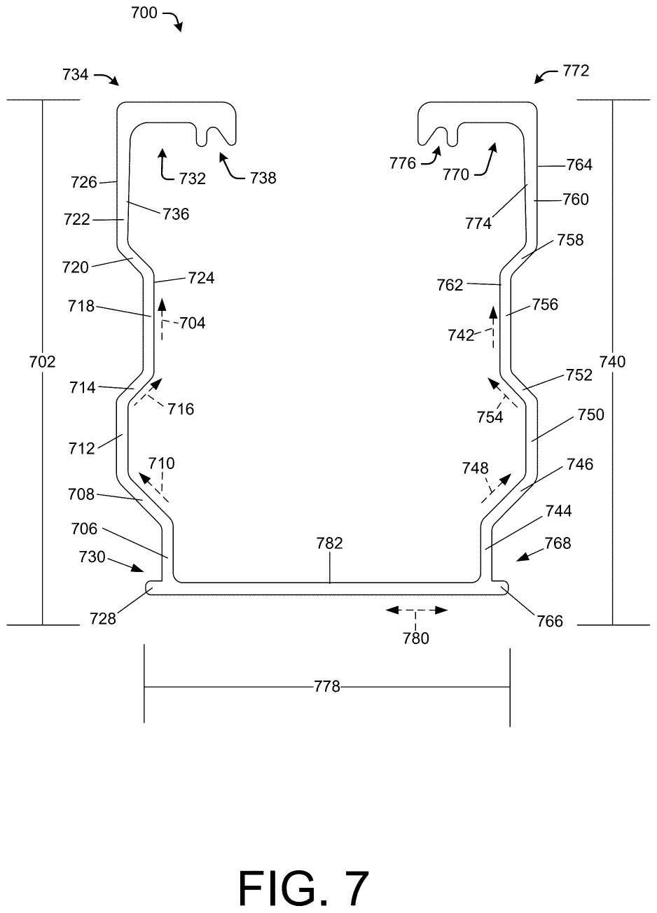

FIG. 7 illustrates a cross-sectional side view of a mounting rail (“rail 700”), according to an embodiment in this disclosure. The rail 700 includes a first vertical wall 702 extending in a first direction 704. The first vertical wall 702 has a first vertical portion 706 extending in the first direction 704, a first angled portion 708 extending in a second direction 710, a second vertical portion 712 extending in the first direction 704, a second angled portion 714 extending from the second vertical portion 712 in the third direction 716, a third vertical portion 718 extending in the first direction 704, a third angled portion 720 extending in the second direction 710, and a fourth vertical portion 722 that extends in the first direction 704.

The first vertical wall 702 has an inside surface 724 opposite an outside surface 726. The first vertical wall 702 includes the first protrusion 728 protruding from the outside surface 726 at a bottom end 730 of the first vertical wall 702 thereof. The first protrusion 728 is correspondingly shaped to be received by a rail mounting clamp (not shown).

The first vertical wall 702 may also include a first inner groove 732 that extends longitudinally along a length of the rail 700 and is disposed at a top end 734 of the inside surface 736 of the fourth vertical portion 722 of the first vertical wall 702. The first inner groove 732 may be configured to receive a top portion of a first vertical wall of a splice rail (not shown in FIG. 7). In an embodiment, the top end 734 of the first vertical wall 702 may be thicker than the bottom end 730 of the first vertical wall 702.

The first vertical wall 702 may include a second inner groove 738 that extends longitudinally along the length of the rail 700 and is adjacent and parallel to the first inner groove 732, and thus also is disposed at the top end 734 of the inside surface 736 of the first vertical wall 702. The second inner groove 738 may be configured to receive a first cooperating portion of a PV component mounting attachment (e.g., a rail nut) (not shown in FIG. 7). As shown, the first inner groove 732 may be located more proximate to the inside surface 736 as compared to the second inner groove 738.

As depicted, the rail 700 includes a second vertical wall 740 that stands opposite from, and extends in, a fourth direction 742 parallel to the first direction 704 of the first vertical wall 702. The second vertical wall 740 has a first vertical portion 744 extending in the fourth direction 742, a first angled portion 746 extending in a fifth direction 748, a second vertical portion 750 extending in the fourth direction 742, a second angled portion 752 extending from the second vertical portion 750 in the sixth direction 754, a third vertical portion 756 extending in the fourth direction 742, a third angled portion 758 extending in the fifth direction 748, and a fourth vertical portion 760 that extends in a the fourth direction 742. The second vertical wall 740 has an inside surface 762 opposite the outside surface 764. The second vertical wall 740 may include the second protrusion 766 protruding from the outside surface 764 of the second vertical wall 740 at a bottom end 768 thereof.

The second vertical wall 740 may include a third inner groove 770 that extends longitudinally along a length of the rail 700 and is disposed at a top end 772 of the inside surface 774 of the fourth vertical portion 760 of the second vertical wall 740. In an embodiment, the top end 772 of the second vertical wall 740 may be thicker than the first vertical portion 744 of the second vertical wall 740. It is also understood that the inside surface 774 of the fourth vertical portion 760 may be tapered inwardly such that the thickness of the fourth vertical portion 760 proximate to the third angled portion 758 is more narrow than fourth vertical portion 760 at the top end 772 of the second vertical wall 740. An advantage of the tapering of the inside surface 774 at the top end 772 of the second vertical wall 740, which creates an increasingly greater wall thickness extending upwardly, may provide additional strength and stability.

The third inner groove 770 may be mirror-symmetric of the first inner groove 732 and may be configured to receive a top portion of a second vertical wall of the splice rail (not shown in FIG. 7). Like the first vertical wall 702, the second vertical wall 740 may include another mirror-symmetrical groove with respect to the second inner groove 738, (e.g., a fourth inner groove 776), that extends longitudinally along the length of the rail 700 and is adjacent and parallel to the third inner groove 770, and thus also is disposed at the top end 772 of the inside surface 774 of the fourth vertical portion 760 of the second vertical wall 740. The fourth inner groove 776 may be configured to receive a second cooperating portion of a PV component mounting attachment (e.g., a rail nut) (not shown in FIG. 7). As shown, the third inner groove 770 may be located more proximate to the inside surface 774 as compared to the fourth inner groove 776.

The rail 700 further includes a horizontal base 778 extending in a seventh direction 780 transverse to the first direction 704 of the first vertical wall 702 and the fourth direction 742 of the second vertical wall 740. The horizontal base 778 includes an inside surface 782. The horizontal base 778 thus connects to, and is integrally formed with, the bottom end 730 of the first vertical wall 702 and the bottom end 768 of the second vertical wall 740.

The various directions referenced in FIG. 7 (e.g., the first direction 704, the second direction 710, the third direction 716, etc.) may be depicted in the present disclosure as being distinct and separate for ease of reference. However, it is understood that in an embodiment, one or more referenced directions may be identified with separate reference numerals but refer to the same direction. For example, in an embodiment, the first direction 704 and the fourth direction 742 may extend in the same direction. Similarly, the second direction 710 and the sixth direction 754 may extend in the same direction parallel to each other, and the third direction 716 and the fifth direction 748 may extend in the same direction parallel to each other.

Additionally, various directions referenced in FIG. 7 may be depicted as being the same (e.g., second direction 710 and the sixth direction 754, etc.). However, it is understood that the directions referenced in FIG. 7 may include one or more alternative orientations. For example, in an embodiment, the second direction 710 and the sixth direction 754 may extend at different angles relative to the horizontal base 778.

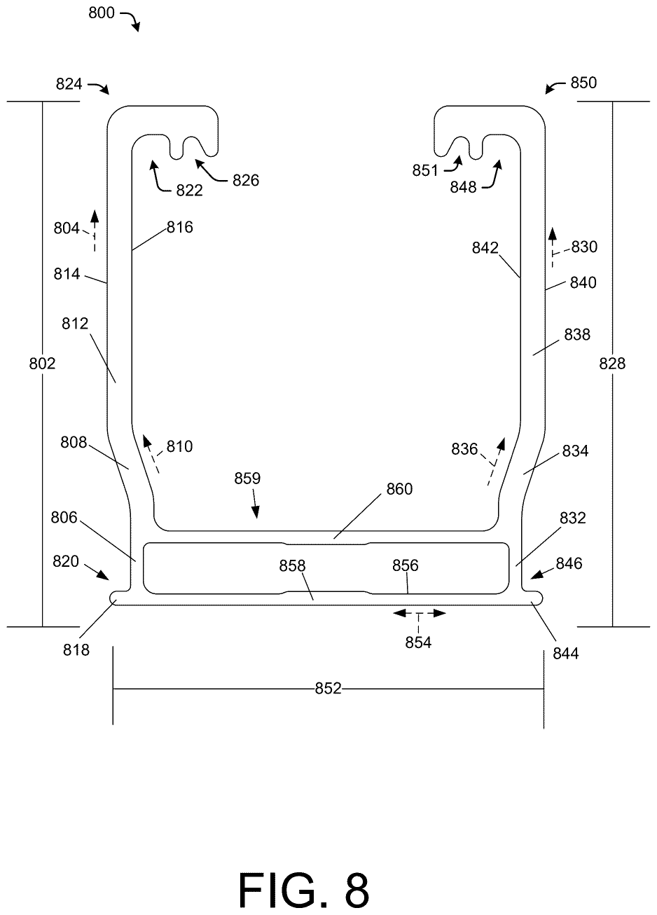

FIG. 8 illustrates a cross-sectional side view of a mounting rail (“rail 800”), according to an embodiment in this disclosure. The rail 800 includes a first vertical wall 802 in a first direction 804. The first vertical wall 802 has a lower portion 806 extending in the first direction 804, an angled portion 808 extending in a second direction 810, and an upper portion 812 extending in the first direction 804. In an embodiment, the angled portion 808 and the upper portion 812 may thicker than the lower portion 806.

The first vertical wall 802 has an outside surface 814 opposite an inside surface 816. The first vertical wall 802 includes the first protrusion 818 protruding from the outside surface 814 at a bottom end 820 of the first vertical wall 802 thereof. The first protrusion 818 is correspondingly shaped to be received by a rail mounting clamp (not shown).

The first vertical wall 802 may also include a first inner groove 822 that extends longitudinally along a length of the rail 800 and is disposed at a top end 824 of the inside surface 816 of the first vertical wall 802. The first inner groove 822 may be configured to receive a top portion of a first vertical wall of a splice rail (not shown in FIG. 8). In an embodiment, the lower portion 806 of the first vertical wall 802 may be thinner than the angled portion 808 and the upper portion 812 of the first vertical wall 802.

The first vertical wall 802 may include a second inner groove 826 that extends longitudinally along the length of the rail 800 and is adjacent and parallel to the first inner groove 822, and thus also is disposed at the top end 824 of the inside surface 816 of the first vertical wall 802. The second inner groove 826 may be configured to receive a first cooperating portion of a PV component mounting attachment (e.g., a rail nut) (not shown in FIG. 8). As shown, the first inner groove 822 may be located more proximate to the inside surface 816 as compared to the second inner groove 826.

As depicted, the rail 800 includes a second vertical wall 828 that stands opposite from, and extends in, a third direction 830 parallel to the first direction 804 of the first vertical wall 802. The second vertical wall 828 has a lower portion 832 extending in the third direction 830, an angled portion 834 extending in a fourth direction 836, and an upper portion 838 extending in the third direction 830. The second vertical wall 828 has an outside surface 840 opposite an inside surface 842. The second vertical wall 828 may include the second protrusion 844 protruding from the outside surface 840 of the second vertical wall 828 at a bottom end 846 thereof.

The second vertical wall 828 may include a third inner groove 848 that extends longitudinally along a length of the rail 800 and is disposed at a top end 850 of the inside surface 842 of the second vertical wall 828. The third inner groove 848 may be mirror-symmetric of the first inner groove 822 and may be configured to receive a top portion of a second vertical wall of the splice rail (not shown in FIG. 8). Like the first vertical wall 802, the second vertical wall 828 may include another mirror-symmetrical groove with respect to the second inner groove 826, (e.g., a fourth inner groove 851), that extends longitudinally along the length of the rail 800 and is adjacent and parallel to the third inner groove 848, and thus also is disposed at the top end 850 of the inside surface 842 of the second vertical wall 828. The fourth inner groove 851 may be configured to receive a second cooperating portion of a PV component mounting attachment (e.g., a rail nut) (not shown in FIG. 8). As shown, the third inner groove 848 may be located more proximate to the inside surface 842 as compared to the fourth inner groove 851.

The rail 800 further includes a horizontal base 852 extending in a fifth direction 854 transverse to the first direction 804 of the first vertical wall 802 and the third direction 830 of the second vertical wall 828. The horizontal base 852 also includes an inside surface 856. The horizontal base 852 thus connects to, and is integrally formed with, the bottom end 820 of the first vertical wall 802 and the bottom end 846 of the second vertical wall 828. The horizontal base 852 may include a middle portion 858 that is reinforced (e.g., middle portion 858 is thicker than the adjacent portions of the horizontal base 852).

The rail 800 further includes a support bridge 859 that extends from the inside surface 816 of the first vertical wall 802 to the inside surface 842 of the second vertical wall 828. The support bridge 859 may include a middle portion 860 that is reinforced (e.g., middle portion 860 is thicker than the adjacent portions of the support bridge 859).

The various directions referenced in FIG. 8 (e.g., first direction 804, second direction 810, third direction 830, etc.) may be depicted in the present disclosure as being distinct and separate for ease of reference. However, it is understood that in an embodiment, one or more referenced directions may be identified with separate reference numerals but refer to the same direction. For example, in an embodiment, the first direction 804 and the third direction 830 may extend in the same direction.

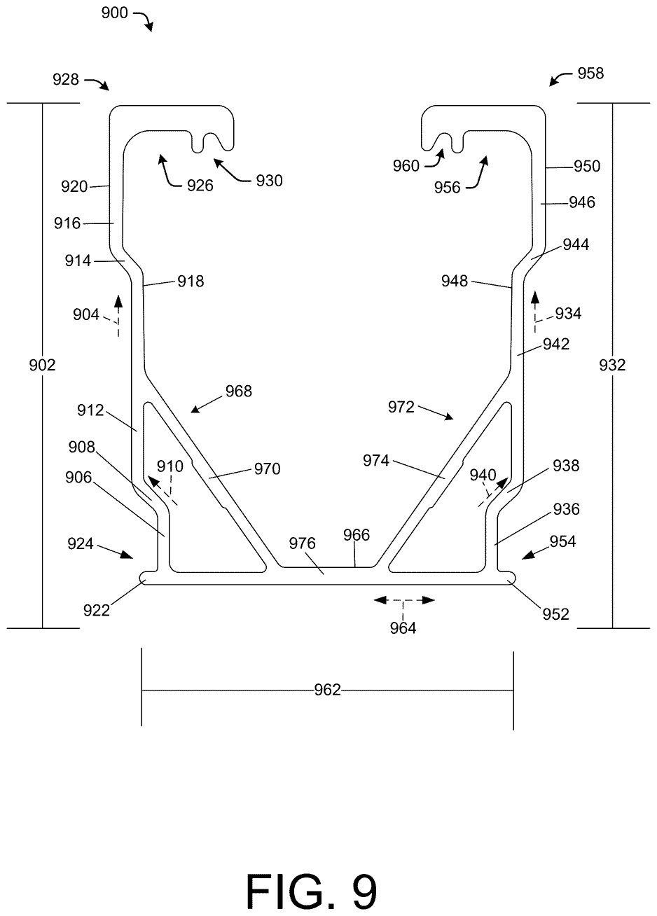

FIG. 9 illustrates a cross-sectional side view of a mounting rail (“rail 900”), according to an embodiment in this disclosure. The rail 900 includes a first vertical wall 902 extending in a first direction 904. The first vertical wall 902 has a lower portion 906 extending in the first direction 904, a first angled portion 908 extending in a second direction 910, a middle portion 912 extending in the first direction 904, a second angled portion 914 extending from the middle portion 912 in a direction away from the middle portion 912, and an upper portion 916 that extends in a direction parallel to the first direction 904.

The first vertical wall 902 has an inside surface 918 opposite an outside surface 920. The first vertical wall 902 includes the first protrusion 922 protruding from the outside surface 920 at a bottom end 924 of the first vertical wall 902 thereof. The first protrusion 922 is correspondingly shaped to be received by a rail mounting clamp (not shown).

The first vertical wall 902 may also include a first inner groove 926 that extends longitudinally along a length of the rail 900 and is disposed at a top end 928 of the inside surface 918 of the first vertical wall 902. The first inner groove 926 may be configured to receive a top portion of a first vertical wall of a splice rail (not shown in FIG. 9). In an embodiment, the top end 928 of the first vertical wall 902 may be thicker than the bottom end 924 of the first vertical wall 902.

The first vertical wall 902 may include a second inner groove 930 that extends longitudinally along the length of the rail 900 and is adjacent and parallel to the first inner groove 926, and thus also is disposed at the top end 928 of the inside surface 918 of the first vertical wall 902. The second inner groove 930 may be configured to receive a first cooperating portion of a PV component mounting attachment (e.g., a rail nut) (not shown in FIG. 9). As shown, the first inner groove 926 may be located more proximate to the inside surface 918 as compared to the second inner groove 930.

As depicted, the rail 900 includes a second vertical wall 932 that stands opposite from, and extends in, a third direction 934 parallel to the first direction 904 of the first vertical wall 902. The second vertical wall 932 has a lower portion 936 extending in the third direction 934, a first angled portion 938 extending in a fourth direction 940, a middle portion 942 extending in the third direction 934, a second angled portion 944 extending from the middle portion 942 in a direction away from the middle portion 942, and an upper portion 946 extending in the third direction 934. The second vertical wall 932 has an inside surface 948 opposite the outside surface 950. The second vertical wall 932 may include the second protrusion 952 protruding from the outside surface 950 of the second vertical wall 932 at a bottom end 954 thereof.

The second vertical wall 932 may include a third inner groove 956 that extends longitudinally along a length of the rail 900 and is disposed at a top end 958 of the inside surface 948 of the second vertical wall 932. The third inner groove 956 may be mirror-symmetric of the first inner groove 926 and may be configured to receive a top portion of a second vertical wall of the splice rail (not shown in FIG. 9). Like the first vertical wall 902, the second vertical wall 932 may include another mirror-symmetrical groove with respect to the second inner groove 930, (e.g., a fourth inner groove 960), that extends longitudinally along the length of the rail 900 and is adjacent and parallel to the third inner groove 956, and thus also is disposed at the top end 958 of the inside surface 948 of the second vertical wall 932. The fourth inner groove 960 may be configured to receive a second cooperating portion of a PV component mounting attachment (e.g., a rail nut) (not shown in FIG. 9). As shown, the third inner groove 956 may be located more proximate to the inside surface 948 as compared to the fourth inner groove 960.

The rail 900 further includes a horizontal base 962 extending in a fifth direction 964 transverse to the first direction 904 of the first vertical wall 902 and the third direction 934 of the second vertical wall 932. The horizontal base 962 includes an inside surface 966. The horizontal base 962 thus connects to, and is integrally formed with, the bottom end 924 of the first vertical wall 902 and the bottom end 954 of the second vertical wall 932.

The rail 900 includes a first support wall 968 that extends from the inside surface 966 of the horizontal base 962 to the inside surface 918 of the first vertical wall 902. The first support wall 968 includes a middle portion 970. The first support wall 968 may extend from the inside surface 966 of the horizontal base 962 to the inside surface 918 of the first vertical wall 902. The middle portion 970 may be reinforced (e.g., thicker than the adjacent portions of the first support wall 968).

The rail 900 includes a second support wall 972 that extends from the inside surface 966 of the horizontal base 962 to the inside surface 948 of the second vertical wall 932. The second support wall 972 includes a middle portion 974. The second support wall 972 may extend from the inside surface 966 of the horizontal base 962 to the inside surface 948 of the second vertical wall 932. The middle portion 974 may be reinforced (e.g., thicker than the adjacent portions of the second support wall 972). The horizontal base 962 also includes a middle portion 576 that extends horizontally between the first support wall 968 and the second support wall 972. In an embodiment, the middle portion 976 may be reinforced (e.g., the middle portion 976 of the horizontal base 962 may be thicker than the adjacent portions of the horizontal base 962).

The various directions referenced in FIG. 9 (e.g., first direction 904, second direction 910, third direction 934, etc.) may be depicted in the present disclosure as being distinct and separate for ease of reference. However, it is understood that in an embodiment, one or more referenced directions may be identified with separate reference numerals but refer to the same direction. For example, in an embodiment, the first direction 904 and the third direction 934 may extend in the same direction.

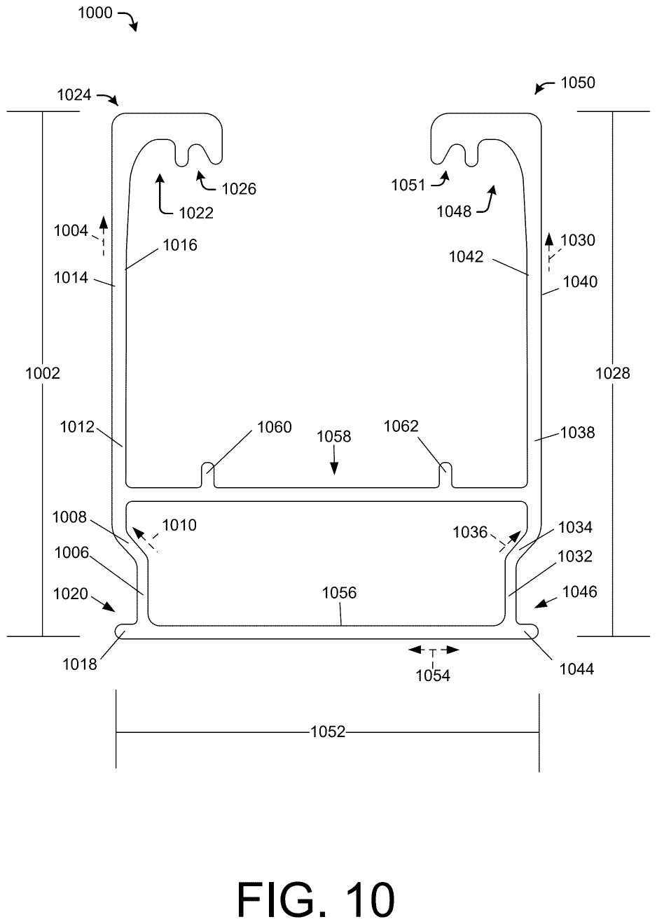

FIG. 10 illustrates a cross-sectional side view of a mounting rail (“rail 1000”), according to an embodiment in this disclosure. The rail 1000 includes a first vertical wall 1002 in a first direction 1004. The first vertical wall 1002 has a lower portion 1006 extending in the first direction 1004, an angled portion 1008 extending in a second direction 1010, and an upper portion 1012 extending in the first direction 1004.

The first vertical wall 1002 has an outside surface 1014 opposite an inside surface 1016. The first vertical wall 1002 includes the first protrusion 1018 protruding from the outside surface 1014 at a bottom end 1020 of the first vertical wall 1002 thereof. The first protrusion 1018 is correspondingly shaped to be received by a rail mounting clamp (not shown).

The first vertical wall 1002 may also include a first inner groove 1022 that extends longitudinally along a length of the rail 1000 and is disposed at a top end 1024 of the inside surface 1016 of the first vertical wall 1002. The first inner groove 1022 may be configured to receive a top portion of a first vertical wall of a splice rail (not shown in FIG. 10). In an embodiment, the top end 1024 of the first vertical wall 1002 may be thicker than the bottom end 1020 of the first vertical wall 1002. It is also understood that the inside surface 1016 of the first vertical wall 1002 may be tapered inwardly such that the lower portion 1006 of the first vertical wall 1002 is narrower than the top end 1024 of the upper portion 1012 of the first vertical wall 1002. An advantage of the tapering of the inside surface 1016 at the top end 1024 of the first vertical wall 1002, which creates an increasingly greater wall thickness extending upwardly, may provide additional strength and stability.

The first vertical wall 1002 may include a second inner groove 1026 that extends longitudinally along the length of the rail 1000 and is adjacent and parallel to the first inner groove 1022, and thus also is disposed at the top end 1024 of the inside surface 1016 of the first vertical wall 1002. The second inner groove 1026 may be configured to receive a first cooperating portion of a PV component mounting attachment (e.g., a rail nut) (not shown in FIG. 10). As shown, the first inner groove 1022 may be located more proximate to the inside surface 1016 as compared to the second inner groove 1026.

As depicted, the rail 1000 includes a second vertical wall 1028 that stands opposite from, and extends in, a third direction 1030 parallel to the first direction 1004 of the first vertical wall 1002. The second vertical wall 1028 has a lower portion 1032 extending in the third direction 1030, an angled portion 1034 extending in a fourth direction 1036, and an upper portion 1038 extending in the first direction 1004. The second vertical wall 1028 has an outside surface 1040 opposite an inside surface 1042. The second vertical wall 1028 may include the second protrusion 1044 protruding from the outside surface 1040 of the second vertical wall 1028 at a bottom end 1046 thereof.

The second vertical wall 1028 may include a third inner groove 1048 that extends longitudinally along a length of the rail 1000 and is disposed at a top end 1050 of the inside surface 1042 of the second vertical wall 1028. The third inner groove 1048 may be mirror-symmetric of the first inner groove 1022 and may be configured to receive a top portion of a second vertical wall of the splice rail (not shown in FIG. 10). Like the first vertical wall 1002, the second vertical wall 1028 may include another mirror-symmetrical groove with respect to the second inner groove 1026, (e.g., a fourth inner groove 1051), that extends longitudinally along the length of the rail 1000 and is adjacent and parallel to the third inner groove 1048, and thus also is disposed at the top end 1050 of the inside surface 1042 of the second vertical wall 1028. The fourth inner groove 1051 may be configured to receive a second cooperating portion of a PV component mounting attachment (e.g., a rail nut) (not shown in FIG. 10). As shown, the third inner groove 1048 may be located more proximate to the inside surface 1042 as compared to the fourth inner groove 1051.

In an embodiment, the top end 1050 of the second vertical wall 1028 may be thicker than the bottom end 1046 of the second vertical wall 1028. It is also understood that the inside surface 1042 of the second vertical wall 1028 may be tapered inwardly such that the lower portion 1032 of the second vertical wall 1028 is more narrow than the top end 1050 of the upper portion 1038 of the second vertical wall 1028. An advantage of the tapering of the inside surface 1042 at the top end 1050 of the second vertical wall 1028, which creates an increasingly greater wall thickness extending upwardly, may provide additional strength and stability.

The rail 1000 further includes a horizontal base 1052 extending in a fifth direction 1054 transverse to the first direction 1004 of the first vertical wall 1002 and the third direction 1030 of the second vertical wall 1028. The horizontal base 1052 also includes an inside surface 1056. The horizontal base 1052 thus connects to, and is integrally formed with, the bottom end 1020 of the first vertical wall 1002 and the bottom end 1046 of the second vertical wall 1028.

The rail 1000 includes a support base 1058 that extends from the inside surface 1016 of the first vertical wall 1002 to the inside surface 1042 of the second vertical wall 1028 in a direction parallel to the fifth direction 1054. The support base 1058 may include a first support protrusion 1060 that extends in a direction away from the support base 1058. The support base 1058 may include a second support protrusion 1062 that extends in a direction away from the support base 1058. The rail 1000 may include a second support protrusion 1060 that extends from the inside surface 1056 of the horizontal base 1052 in a direction away from the horizontal base 1052.

The various directions referenced in FIG. 10 (e.g., first direction 1004, second direction 1010, third direction 1030, etc.) may be depicted in the present disclosure as being distinct and separate for ease of reference. However, it is understood that in an embodiment, one or more referenced directions may be identified with separate reference numerals but refer to the same direction. For example, in an embodiment, the first direction 1004 and the third direction 1030 may extend in the same direction.

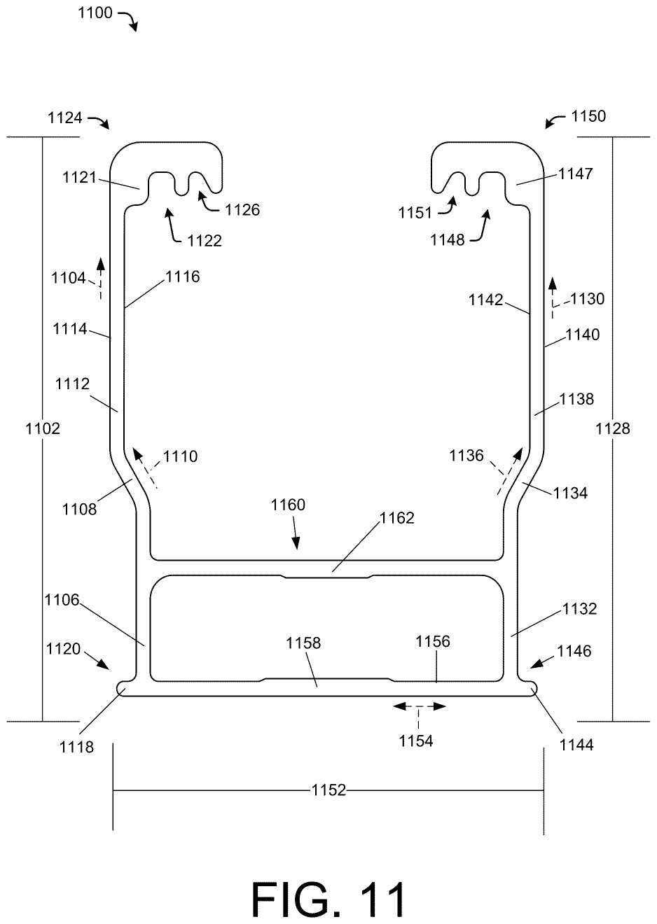

FIG. 11 illustrates a cross-sectional side view of a mounting rail (“rail 1100”), according to an embodiment in this disclosure. The rail 1100 includes a first vertical wall 1102 in a first direction 1104. The first vertical wall 1102 has a lower portion 1106 extending in the first direction 1104, an angled portion 1108 extending in a second direction 1110, and an upper portion 1112 extending in the first direction 1104.

The first vertical wall 1102 has an outside surface 1114 opposite an inside surface 1116. The first vertical wall 1102 includes the first protrusion 1118 protruding from the outside surface 1114 at a bottom end 1120 of the first vertical wall 1102 thereof. The first protrusion 1118 is correspondingly shaped to be received by a rail mounting clamp (not shown).

The first vertical wall 1102 may include a shouldered portion 1121 that extends from the inside surface 1116 towards a first inner groove 1122 that extends longitudinally along a length of the rail 1100 and is disposed at a top end 1124 of the inside surface 1116 of the first vertical wall 1102. The first inner groove 1122 may be configured to receive a top portion of a first vertical wall of a splice rail (not shown in FIG. 11).

The first vertical wall 1102 may include a second inner groove 1126 that extends longitudinally along the length of the rail 1100 and is adjacent and parallel to the first inner groove 1122, and thus also is disposed at the top end 1124 of the inside surface 1116 of the first vertical wall 1102. The second inner groove 1126 may be configured to receive a first cooperating portion of a PV component mounting attachment (e.g., a rail nut) (not shown in FIG. 11). As shown, the first inner groove 1122 may be located more proximate to the inside surface 1116 as compared to the second inner groove 1126.

As depicted, the rail 1100 includes a second vertical wall 1128 that stands opposite from and extends in, a third direction 1130 parallel to the first direction 1104 of the first vertical wall 1102. The second vertical wall 1128 has a lower portion 1132 extending in the third direction 1130, an angled portion 1134 extending in a fourth direction 1136, and an upper portion 1138 extending in the third direction 1130. The second vertical wall 1128 has an outside surface 1140 opposite an inside surface 1142. The second vertical wall 1128 may include the second protrusion 1144 protruding from the outside surface 1140 of the second vertical wall 1128 at a bottom end 1146 thereof.

The second vertical wall 1128 may include a shouldered portion 1147 that extends from the inside surface 1142 towards a third inner groove 1148 that extends longitudinally along a length of the rail 1100 and is disposed at a top end 1150 of the inside surface 1142 of the second vertical wall 1128. The third inner groove 1148 may be mirror-symmetric of the first inner groove 1122 and may be configured to receive a top portion of a second vertical wall of the splice rail (not shown in FIG. 11). Like the first vertical wall 1102, the second vertical wall 1128 may include another mirror-symmetrical groove with respect to the second inner groove 1126, (e.g., a fourth inner groove 1151), that extends longitudinally along the length of the rail 1100 and is adjacent and parallel to the third inner groove 1148, and thus also is disposed at the top end 1150 of the inside surface 1142 of the second vertical wall 1128. The fourth inner groove 1151 may be configured to receive a second cooperating portion of a PV component mounting attachment (e.g., a rail nut) (not shown in FIG. 11). As shown, the third inner groove 1148 may be located more proximate to the inside surface 1142 as compared to the fourth inner groove 1151.

The rail 1100 further includes a horizontal base 1152 extending in a fifth direction 1154 transverse to the first direction 1104 of the first vertical wall 1102 and the third direction 1130 of the second vertical wall 1128. The horizontal base 1152 also includes an inside surface 1156. The horizontal base 1152 thus connects to, and is integrally formed with, the bottom end 1120 of the first vertical wall 1102 and the bottom end 1146 of the second vertical wall 1128. The horizontal base 1152 may include a middle portion 1158 that is reinforced (e.g., middle portion 1158 is thicker than the adjacent portions of the horizontal base 1152).

The rail 1100 further includes a support bridge 1160 that extends from the inside surface 1116 of the first vertical wall 1102 to the inside surface 1142 of the second vertical wall 1128. The support bridge 1160 may include a middle portion 1162 that is reinforced (e.g., middle portion 1162 is thicker than the adjacent portions of the support bridge 1160).

The various directions referenced in FIG. 11 (e.g., first direction 1104, second direction 1110, third direction 1130, etc.) may be depicted in the present disclosure as being distinct and separate for ease of reference. However, it is understood that in an embodiment, one or more referenced directions may be identified with separate reference numerals but refer to the same direction. For example, in an embodiment, the first direction 1104 and the third direction 1130 may extend in the same direction.

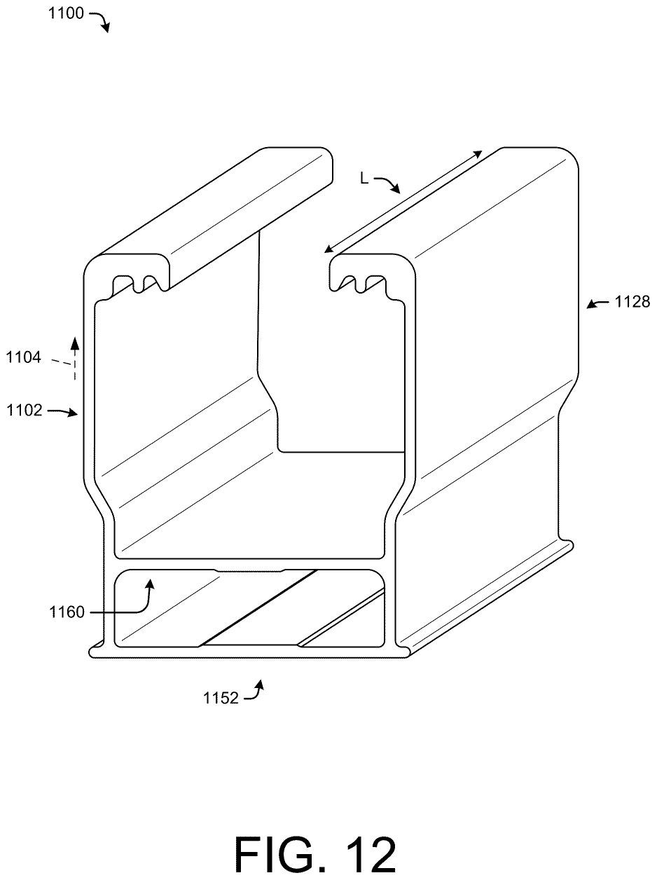

FIG. 12 illustrates a top-front perspective view of the mounting rail (“rail 1100”) of FIG. 11, according to an embodiment of this disclosure. In an embodiment, the rail 1100 includes the first vertical wall 1102 and the second vertical wall 1128, each of which extends primarily in the first direction 1104 with respect to the horizontal base 1152 and the support bridge 1160. Thus, an overall U-shaped channel may be defined by a cross-sectional view of the first vertical wall 1102, the second vertical wall 1128 and the horizontal base 1152, when the horizontal base 1152 is oriented horizontally. Likewise, an overall U-shaped channel may be defined by a cross-sectional view of the first vertical wall 1102, the second vertical wall 1128 and the support bridge 1160, when the support bridge 1160 is oriented horizontally.

### CONCLUSION

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

What is claimed is:

1. A mounting rail system comprising:
a rail segment, including:
a first vertical wall extending in a first direction and including:
a first lower portion,
a first angled portion extending from the first lower portion in a second direction transverse to the first direction, and
a first upper portion extending from the first angled portion;
a second vertical wall that extends in a third direction parallel to the first direction of the first vertical wall, the second vertical wall including:
a second lower portion,
a second angled portion extending from the second lower portion in a fourth direction transverse to the third direction, and
a second upper portion extending from the first angled portion;
a horizontal base extending in a fifth direction transverse to the first direction and the third direction, the horizontal base being integrally formed with the first vertical wall and the second vertical wall;
a first support wall extending from the horizontal base to the first vertical wall;
a second support wall extending from the horizontal base to the second vertical wall; and
a support bridge extending from the first support wall to the second support wall.

2. The mounting rail system according to claim 1, wherein:
the first vertical wall further includes:
a first outside surface,
a first inside surface,
a first protrusion extending from the first outside surface,
a first inner groove disposed at a top end of the first inside surface, the first inner groove being configured to receive a first portion of a splice rail, and
a second inner groove disposed at the top end of the first inside surface laterally adjacent to the first inner groove such that the first inner groove is more proximate to the first inside surface than the second inner groove, the second inner groove being configured to receive a first portion of a rail nut; and
the second vertical wall further includes:
a second outside surface,
a second inside surface,
a second protrusion extending from the second outside surface,
a third inner groove disposed at a top end of the second inside surface, the third inner groove being configured to receive a second portion of the splice rail, and
a fourth inner groove disposed at the top end of the second inside surface laterally adjacent to the third inner groove such that the third inner groove is more proximate to the second inside surface than the fourth inner groove, the fourth inner groove being configured to receive a second portion of the rail nut.

3. The mounting rail system according to claim 1, wherein:
the support bridge includes:
a first side portion extending from the first support wall,
a middle portion extending from the first side portion towards the second support wall, and
a second side portion extending from the middle portion to the second support wall; and
the middle portion is thicker than the first side portion and the second side portion.

4. The mounting rail system according to claim 1, wherein:
the rail segment is a first rail segment, and
the mounting rail system further comprises:
a second rail segment; and
a splice rail configured to connect the first rail segment to the second rail segment, the splice rail including:
a first vertical wall that extends in a first direction,
a second vertical wall that extends in a second direction adjacent to the first direction of the first vertical wall,
a base of the splice rail extending in a direction parallel to the support bridge, the base of the splice rail integrally formed with a bottom portion of the first vertical wall of the splice rail and a bottom portion of the second vertical wall of the splice rail, and
a fastener, and
upon assembling the first rail segment with the second rail segment, the fastener is disposed through the base of the splice rail such that a head of the fastener is disposed between the first vertical wall of the splice rail and the second vertical wall of the splice rail.

5. The mounting rail system according to claim 4, wherein the fastener is disposed through a middle portion of the support bridge of the first rail segment.

6. The mounting rail system according to claim 4, wherein the fastener is disposed through:
a middle portion of the support bridge of the first rail segment, and
the horizontal base of the first rail segment.

7. The mounting rail system according to claim 4, wherein:
the fastener is a first fastener; and
the splice rail further includes a second fastener, which upon installation of the mounting rail system, is disposed through the base of the splice rail such that the head of second fastener is disposed between the first vertical wall of the splice rail and the second vertical wall of the fastener.

8. A mounting rail comprising:
a first vertical wall that extends in a first direction, the first vertical wall including:
a first lower portion,
a first angled portion extending from the first lower portion in a second direction transverse to the first direction, and
a first upper portion extending from the first angled portion;
a second vertical wall that extends in a third direction parallel to the first direction of the first vertical wall, the second vertical wall including:
a second lower portion,
a second angled portion extending from the second lower portion in a fourth direction transverse to the third direction, and
a second upper portion extending from the first angled portion;
a horizontal base extending in a fourth direction transverse to the first direction and the third direction, the horizontal base being integrally formed with the first vertical wall and the second vertical wall; and
a support structure extending from the first vertical wall to the second vertical wall.

9. The mounting rail according to claim 8, wherein:
the first vertical wall further includes:
a first outside surface,
a first inside surface,
a first protrusion extending from the first outside surface,
a first inner groove disposed at a top end of the first inside surface, the first inner groove being configured to receive a first portion of a splice rail, and
a second inner groove disposed at the top end of the first inside surface laterally adjacent to the first inner groove such that the first inner groove is more proximate to the first inside surface than the second inner groove, the second inner groove being configured to receive a first portion of a rail nut; and
the second vertical wall further includes:
a second outside surface,
a second inside surface,
a second protrusion extending from the second outside surface,
a third inner groove disposed at a top end of the second inside surface, the third inner groove being configured to receive a second portion of the splice rail, and
a fourth inner groove disposed at the top end of the second inside surface laterally adjacent to the third inner groove such that the third inner groove is more proximate to the second inside surface than the fourth inner groove, the fourth inner groove being configured to receive a second portion of the rail nut.

10. The mounting rail according to claim 8, the support structure further comprising:
a first support wall extending from the horizontal base to the first vertical wall;
a second support wall extending from the horizontal base to the second vertical wall; and
a bridge extending from the first support wall to the second support wall.

11. The mounting rail according to claim 8, the support structure further comprising:
a first support wall extending from the horizontal base to the first vertical wall; and
a second support wall extending from the horizontal base to the second vertical wall.

12. The mounting rail according to claim 11, wherein:
the first support wall includes:
a first side portion extending from the first support wall towards the horizontal base,
a middle portion extending from the first side portion towards the horizontal base, and
a second side portion extending from the middle portion to the horizontal base; and
the second support wall includes:
a first side portion extending from the second support wall towards the horizontal base,
a middle portion extending from the first side portion towards the horizontal base, and
a second side portion extending from the middle portion to the horizontal base.

13. The mounting rail according to claim 10, wherein:
the first support wall includes:
a first side portion extending from the first vertical wall,
a middle portion extending from the first side portion, the middle portion being thicker than the first side portion, and
a second side portion extending from the middle portion to the horizontal base, the middle portion being thicker than the second side portion; and
the second support wall includes:
a first side portion extending from the second vertical wall,
a middle portion extending from the first side portion, the middle portion being thicker than the first side portion, and
a second side portion extending from the middle portion to the horizontal base, the middle portion being thicker than the second side portion.

14. A mounting rail system, comprising:
a rail segment including:
a first vertical wall that extends in a first direction, the first vertical wall including:
a first lower portion,
a first angled portion extending from the first lower portion in a second direction transverse to the first direction,
a first lower curved portion extending from the first angled portion in a third direction transverse to the first direction,
a first middle portion extending from the first lower curved portion in the first direction, and
a first upper curved portion extending from the first middle portion;
a second vertical wall that extends in a fourth direction parallel to the first direction of the first vertical wall, the second vertical wall including:
a second lower portion,
a second angled portion extending from the second lower portion in a fifth direction transverse to the fourth direction,
a second lower curved portion extending from the second angled portion in a sixth direction transverse to the third direction,
a second middle portion extending from the second lower curved portion in the third direction, and
a second upper curved portion extending from the second middle portion;
a horizontal base extending in a seventh direction transverse to the first direction and the third direction, the horizontal base being integrally formed with the first vertical wall and the second vertical wall; and
a support protrusion extending from the horizontal base to the second vertical wall.

15. The mounting rail system according to claim 14, wherein:
the first vertical wall further includes:
a first outside surface,
a first inside surface,
a first protrusion extending from the first outside surface,
a first inner groove disposed at a top end of the first inside surface, the first inner groove being configured to receive a first portion of a splice rail, and
a second inner groove disposed at the top end of the first inside surface laterally adjacent to the first inner groove such that the first inner groove is more proximate to the first inside surface than the second inner groove, the second inner groove being configured to receive a first portion of a rail nut; and
the second vertical wall further includes:
a second outside surface,
a second inside surface,
a second protrusion extending from the second outside surface,
a third inner groove disposed at a top end of the second inside surface, the third inner groove being configured to receive a second portion of the splice rail, and
a fourth inner groove disposed at the top end of the second inside surface laterally adjacent to the third inner groove such that the third inner groove is more proximate to the second inside surface than the fourth inner groove, the fourth inner groove being configured to receive a second portion of the rail nut.

16. The mounting rail system according to claim 14, wherein the support protrusion includes:
a first section extending from the first vertical wall towards the horizontal base,
a middle section extending from the first section towards the second vertical wall, and
a second section extending from the middle section to the second vertical wall, the middle section is thicker than the first section and the second section.

17. The mounting rail system according to claim 14, wherein:
the rail segment is a first rail segment;
the mounting rail system further comprises:
a second rail segment, and
a splice rail configured to connect the first rail segment to the second rail segment, the splice rail including:
a first vertical wall that extends in a first direction,
a second vertical wall that extends in a second direction adjacent to the first direction of the first vertical wall,
a base of the splice rail extending in a direction parallel to the support protrusion, the base of the splice rail integrally formed with a bottom portion of the first vertical wall of the splice rail and a bottom portion of the second vertical wall of the splice rail, and
a fastener; and
upon assembling the first rail segment with the second rail segment, the fastener is disposed through the base of the splice rail such that a head of the fastener is disposed between the first vertical wall of the splice rail and the second vertical wall of the splice rail.

18. The mounting rail system according to claim 17, wherein the fastener is disposed through a middle section of the support protrusion of the first rail segment.

19. The mounting rail system according to claim 17, wherein the fastener is disposed through:
a middle section of the support protrusion, and
the horizontal base of the first rail segment.

20. The mounting rail system according to claim 17, wherein:
the fastener is a first fastener, and
the splice rail further includes a second fastener configured to extend through the base of the splice rail such that a head of second fastener is disposed between the first vertical wall of the splice rail and the second vertical wall of the fastener.
